(19) United States
(12) Patent Application Publication
(10) Pub. No.: US 2006/0023611 A1
(43) Pub. Date: Feb. 2, 2006

(54) Compound optical element and optical pickup apparatus

(76) Inventors: Mika Wachi, Tokyo (JP); Tohru Kimura, Tokyo (JP); Kiyono Ikenaka, Tokyo (JP)

Correspondence Address: CANTOR COLBURN, LLP, 55 GRIFFIN ROAD SOUTH, BLOOMFIELD, CT, 06002, US

(21) Appl. No.: 11/183,608

(22) Filed: Jul. 18, 2005

(30) Foreign Application Priority Data
Jul. 23, 2004 (JP) JP2004-216243
Sep. 1, 2004 (JP) JP2004-254368

(51) Int. Cl. G11B 7/00

(52) U.S. Cl. 369/112.23; 369/44.23

(57) ABSTRACT

The present invention provides a compound optical element for an optical pickup apparatus, including: an aspherical lens and a resin layer arranged on at least one optical surface of the aspherical lens and having a phase structure, wherein the compound optical element satisfies a predetermined condition for optical path lengths of a light flux which passes the resin layer. The present invention also provides a compound optical element for an optical pickup apparatus including: a first lens part with a predefined Abbe number; a second lens part with a predefined Abbe number laminated on the first lens part and a phase structure formed on a boundary between the first lens part and air.

This application is based on Japanese Patent Application Nos. 2004-216243 filed on Jul. 23, 2004, and 2004-254368 filed on Sep. 1, 2004 in Japanese Patent Office, the entire content of which is hereby incorporated by reference.

### FIELD OF THE INVENTION

The present invention relates to a compound optical element used for an optical pickup apparatus and the optical pickup apparatus.

### BACKGROUND OF THE INVENTION

Recently, in the optical pickup apparatus, wavelength-shortening of a laser light source used as the light source for the reproducing of the information recorded in an optical disc or the recording of the information in the optical disc, is advanced, for example, a laser light source of wavelength 405 nm such as the blue violet semiconductor laser, or the blue violet SHG laser which conducts the wavelength conversion of the infrared semiconductor laser by using the second harmonics generation, is putting to practical use.

In the case where these blue violet laser light sources are used, when an objective lens of the same numerical aperture (NA) as a digital versatile disc (hereinafter, abbreviated as DVD) is used, the information of 15-20 GB can be recorded in an optical disc of 12 cm diameter, and when NA of the objective lens is heightened to 0.85, the information of 23-27 GB can be recorded in the optical disc of 12 cm diameter. Hereinafter, in the present specification, the optical disc for which the blue violet laser light source is used, or photo-magnetic disc are generally named as “high density optical disc”.

Hereupon, as the high density optical disc, presently, 2 standards are proposed. One of them is Blu-ray disc (hereinafter, it is abbreviated as BD) using an objective lens of NA 0.85 and whose protective layer thickness is 0.1 mm, and another one is a HD DVD (hereinafter, abbreviated as HD) using an objective lens of NA 0.65 to 0.67 and whose protective layer thickness is 0.6 mm. In optical discs such as the high density optical disc whose recording density is increased by using the blue violet laser light source, DVD (red laser light source is used), CD (infrared laser light source is used), conventionally, a development of the optical information recording reproducing apparatus having the compatibility between at least 2 kinds of optical discs is advanced.

In view of the possibility that, in the future, these 2-standard high density optical discs are circulated in the market, a compatibility-use optical pickup apparatus by which the recording and/or reproducing can be conducted also on any one of high density optical discs, that is, also on the existing DVD, is important.

As an objective lens requiring the high numerical aperture for the high density optical disc, for example, the objective lens of 2-lens composition in which glass mold aspherical surface lens is combined with plastic optical element having the diffractive structure, is well known. As a reason for which it is made into 2-lens composition, it is listed that, when it is the aspherical surface lens of glass mold one lens composition, the correction of the chromatic aberration due to the sudden wavelength variation (mode hop) of the light source is not enough by its single body.

The plastic optical element of this composition is an optical element having a purpose for the correction of the chromatic aberration due to the wavelength variation of about several nm by using the diffractive structure, or for the compatibility with DVD/CD (compact disc) whose using wavelengths are different, however, in such a combination lens composed of at least more than 2 kinds of optical elements, when considered that an increase of man-hours for the assembly and adjustment, or it is difficult that it is used for a thin-type optical pickup apparatus from a reason that the thickness in the optical axis direction is increased, it is preferable that the composition of the objective lens is 1.

Hereupon, as a DVD/CD compatibility use, an objective lens which is 1-lens composition having the diffractive structure on whose surface, and a plastic injection molded aspherical surface, is well known, however, when an objective lens of high numerical aperutre more than NA 0.8 is formed of plastic, the assurance of the deterioration of spherical aberration due to the refractive index variation by the temperature change becomes difficult.

Further, when the optical path difference providing structure is formed on the optical surface by using glass as a material, it is necessary that the temperature of the mold is increased for the purpose that the transferability of the metallic mold is increased. However, in this method, because it is necessary that the temperature of the metallic mold is increased at least to glass transposition point, the damage of the metallic mold becomes large. Further, because the life of the metallic mold becomes short, it is necessary that the metallic mold is replaced frequently, resulting in the increase of cost.

In consideration of the above described problems, in the following Patent Document 1, an objective lens for the optical pickup apparatus in which a resin layer is provided on the optical surface of the glass aspherical surface lens, and on this resin layer, the diffractive structure is provided, is written.

[Patent Document 1] Tokkai No. 2000-40247

The technology written in Patent Document 1 is a technology for a purpose that the life of the metallic mold is increased when the resin whose melting temperature is low, or the ultraviolet curing resin is injected into the metallic mold on which the diffractive structure is transferred, however, when this technology is applied for the objective lens of 1-group composition whose NA is large, due to a reason that the difference of thickness of resin layer in the vicinity of the optical axis and in the periphery of an effective diameter is increased, the influence of the optical path length change at the time of temperature change becomes large, and a problem that the temperature characteristic is deteriorated, is generated.

Further, from a viewpoint of size-reduction or weight-reduction of the apparatus, it is desirable that a plurality of kinds of optical discs can be recorded and/or reproduced by one optical pickup apparatus, further, such an optical pickup apparatus provides with only one objective lens, and this objective optical element is composed of a single lens (for example, refer to Patent Documents 2-5).

[Patent Document 2] Tokkai No. 2004-079146

[Patent Document 3] Tokkai No. 2002-298422

[Patent Document 4] Tokkai No. 2003-207714

[Patent Document 5] Tokkai No. 2003-232997

The numerical example 7 of Patent Document 2 discloses, that an objective lens including a diffractive structure on the surface of the objective lens, such that the diffractive structure generates 2nd-order diffraction light in the blue violet laser light flux, and 1st-order diffraction light in the red laser light flux and the infrared laser light flux. This diffractive structure corrects the spherical aberration due to the difference of the protective layer thickness between the high density optical disc and DVD by an action of the diffractive structure, and further corrects the spherical aberration due to the difference of the protective layer thickness between the high density optical disc and DVD by the divergent light flux entering into the objective lens at the time of the recording/reproducing of the information on CD. In this objective lens, although the diffraction efficiency can be secured highly in any wavelength range, at the time of the recording/reproducing of the information on CD, because the degree of divergence of the infrared laser light flux is too strong, and because the coma generation when the objective lens conducts the tracking is too large, there is a problem that a good recording/reproducing characteristic on CD can not be obtained.

Further, the numerical example 3 of Patent Document 3 discloses an objective lens including on the surface of the objective lens, such that the diffractive structure generates 3rd order diffraction light flux in the blue violet laser light flux, and 2nd order diffraction light flux in the red laser light flux and the infrared laser light flux. The objective lens corrects the spherical aberration due to the difference of protective layer thickness among the high density optical disc, DVD and CD.

This objective lens can correct the spherical aberration due to the difference of the protective layer thickness between the high density optical disc and DVD, further, the spherical aberration due to the difference of the protective layer thickness between the high density optical disc and CD by the action of the diffractive structure. However, there is a problem that, it can not correspond to the speeding-up of the recording/reproducing speed on the optical disc because the diffraction efficiency of the 3rd order diffraction light of the blue violet laser light flux and the diffraction efficiency of the 2nd order diffraction light of the infrared laser light flux are about 70%, which is low; a good recording/reproducing characteristic can not be obtained because S/N ratio of the detection signal in the photo-detector is low; and the life of the laser light source becomes short because the voltage applied on the laser light source becomes high.

As a reason that the spherical aberration due to the difference of the protective layer thickness between the high density optical disc and CD can not be corrected by the diffractive structure in the objective lens written in Patent Document 2, or as a reason that the diffraction efficiency of the 3rd-order diffraction light of the blue violet wavelength area and the diffraction efficiency of the 2nd-order diffraction light of the infrared wavelength area become low in the objective lens written in Patent Document 3, it is listed that the spherical aberration correction effect to the blue violet laser light flux and the infrared laser light flux of the diffraction light generated by the diffractive structure, and the diffraction efficiency of the diffraction light are in the relationship of trade-off each other because the wavelength of the infrared laser light source used for CD is about 2 times to the wavelength of the blue violet laser light source used for the high density optical disc.

That is, in the objective lens of the numerical example 7 of Patent Document 2 corresponding to a case where both of the diffraction efficiency of the diffraction light of the blue violet laser light flux and the diffraction efficiency of the diffraction light of the infrared laser light flux are secured highly, the spherical aberration due to the difference of the protective layer thickness between the high density optical disc and CD can not be corrected by the diffractive structure because the diffraction angle of the diffraction light of the blue violet laser light flux almost coincides with the diffraction angle of the diffraction light of the infrared laser light flux.

Further, as described above, it is most desirable that the compatibility among 3 kinds of optical discs are attained by using the objective optical element composed of a single lens. However, it was difficult that the aberration generated at the time of tracking is corrected in a resin lens in which the diffractive structure is provided on the material surface of normal dispersion, or as in Patent Document 5, the diffractive structure is formed on the resin layer formed on the glass surface although the chromatic aberration can be corrected. It is a cause that, both of the diffraction efficiency of the diffraction light of the blue violet laser light flux and the diffraction efficiency of the diffraction light of the infrared laser light flux, become low in the objective lens of the numerical example 3 of Patent Document 3 corresponding to a case where the difference is given between the diffraction angle of the diffraction light of the blue violet laser light flux and the diffraction angle of the diffraction light of the infrared laser light flux.

Hereupon, not only the diffractive structure written in Patent Documents 2 and 3, but also in the technology using the phase correction structure (in the present specification, it is called as optical path difference providing structure) as written in Patent Document 4, in the same manner as in the diffractive structure, the spherical aberration correction effect to the blue violet laser light flux and the infrared laser light flux by the optical path difference providing structure, and the transmission factor of the optical path difference providing structure, are in the relationship of trade-off each other.

### SUMMARY OF THE INVENTION

An object of the present invention is, considering the above-described problems, to provide a compound optical element which is low cost and by which the man-hour of the adjusting operation at the time of the assembly can be reduced, and an optical pickup apparatus having this compound optical element.

Further, a further object of the present invention is to provide a compound optical element by which these 2 light fluxes can be projected each other at different angle by using the diffractive structure in order to attain the compatibility between the high density optical disc and CD, which are in the relationship that a ratio of wavelengths of the using light fluxes is about 1:2, and an optical pickup apparatus in which this compound optical element is mounted.

In order to solve the above-described object, the structure written in item 1 is a compound optical element for an optical pickup apparatus, having an aspherical lens, and a resin layer arranged on at least one optical surface of the aspherical lens and having a phase structure. A ratio of L and L′ of the compound optical element satisfies the expression (1), where L′ is an optical path length of a light flux which enters into the compound optical element and passes the resin layer on an edge of an effective diameter which corresponds to a necessary numerical aperture, and L is an optical path length of a light flux which enters into the compound optical element and passes the resin layer on an optical axis.
0.8≦(L′/L)≦1.2 (1)

In the present specification, “the necessary numerical aperture” is a numerical aperture necessary to form the spot necessary for recording or reproducing of the information.

As in item 1, L′/L within the above range can adequately conduct chromatic aberration correction by using the diffractive structure provided on the resin layer or the correction of the spherical aberration due to the refractive index change of the resin layer by the change of the environmental temperature, or the correction of the coma when the off-axis light is incident on the objective lens.

Particularly, L′/L within the above range can be suppress a generation amount of the spherical aberration due to the refractive index variation by the temperature change, when the compound optical element is used as the objective lens, and for example, even when the high numerical aperture for the high density optical disc is required.

When L′/L is smaller the lower limit, the correction of the chromatic aberration becomes insufficient, and when L′/L is larger than the upper limit, the correction of the spherical aberration when the environmental temperature is changed, or the correction of the coma generation becomes insufficient.

Further, when the diffractive structure is not formed directly on the optical surface of the lens of the aspherical surface, but formed on the resin on the optical surface, the manufacturing process of the compound optical element can be simplified. As the result, the compound optical element can be manufactured at low cost. Further, as compared to the cases where the diffractive structure is formed in the optical element which is a separated body from the aspherical surface lens, and this optical element is combined with a lens of the aspherical surface, and they are integrated, the man-hour of the adjusting operation at the time of assembly can be more reduced.

The structure written in item 16 is a compound optical element for an optical pickup apparatus, at least reproducing and/or recording information using a light flux with a wavelength λ1 emitted by a first light source for a first optical disc having a protective substrate with a thickness t1 and reproducing and/or recording information using a light flux with a wavelength λ2 (1.8×λ1≦λ2≦2.2×λ1) emitted by a second light source for a second optical disc having a protective substrate with a thickness t2 (1.7×t1≦t2). The compound optical element is provided with: a first lens part comprising a material A having an Abbe number vd for a d-line satisfies 20≦vdA≦40; a second lens part laminated on the first lens part in a direction of an optical axis and comprising a material B; having an Abbe number vd for a d-line satisfies 40≦vdB≦70, wherein the first lens part and the second lens part form one lens body; and a phase structure formed on a boundary between the first lens part and air.

It is preferable that the compound optical element described above is an objective lens of the optical pickup apparatus.

In the structure described in item 16, the phase structure is formed on a boundary between the first lens part and air, which is an opposite side of the first lens part to a boundary between the first lens part and the second lens part.

When the compound optical element is configured as shown in item 16, light fluxes whose wavelength ratio stand in the relationship of approximately 1:2 (e.g. blue-violet laser beam having a wavelength of λ1 of about 407 nm), such as a light flux with wavelength λ1 and a light flux with wavelength λ3 (e.g. infrared laser beam having a wavelength λ3 of about 785 nm), can be emitted at mutually different angles, using the first phase structure. This ensures compatibility between the correction of spherical aberration caused by the difference in thicknesses of protective substrates t1 and t3, and a high degree of transmittance of the light flux of each wavelength.

To put it more specifically, the diffractive structure HOE (see FIGS. 14(a) and 14(b)) which is one sample of the phase structure, is formed on the boundary between the air layer and the lens part comprising the materials A with an Abbe number of 20≦nd<40, including a plurality of patterns P arranged concentrically and each of the patterns has stepped cross section including the optical axis. Each pattern is structured in such a way that the step S is shifted for each of the levels in the specified number (5 levels in FIGS. 13(a) and 13(b)) by the height corresponding to the number of steps conforming to the number of levels (4 steps in FIGS. 13(a) and 3(b)).

When a diffractive structure is formed on the surface of an compound optical element such as the prior art system, the following expression (51) will hold, where the depth of each step of each pattern in the direction of optical axis is d1; the refractive index at the wavelength λ1 (=407 nm) of the material C of the objective optical system is n_{c407}; the refractive index at the wavelength λ2 (=785 nm) of the material C of the compound optical element is n_{c785}; the refractive index of an air is 1; and each step constituting each pattern is designed so that the light flux of wavelength λ1 can pass through, namely, that a phase difference is not vertically assigned to the light flux of wavelength λ1.
d1(n_{c407}-1)≈407×N1 (where N1 denotes a natural number) (51)

If a light flux of wavelength λ2 has entered the diffractive structure designed in the aforementioned manner, the following expression (52) will hold:
d1(n_{C785}−1)≈785×N1/2 (52)

This is from a reason that, as compared to a ratio of the wavelengths of the incident light fluxes (407:785≈1:2), because a ratio of the difference of the refractive indexes (n_{C407}−1)/(n_{C785}−1) of the material C and the air is enough close to 1, the left side of the expression (51) and the left side of the expression (52) become about the same value, and a value to multiply 785 of the right side of the expression (52) becomes ½ of the natural number N1, and when N1 is even number, as the result, when the light is incident on it, the phase difference given by each ring-shaped zone of the diffractive structure becomes the same in the light of wavelength λ1 and in the light of wavelength λ2, and the light is diffracted in the same direction or transmitted.

Accordingly, in the structure of item 16, the compound optical element is formed as a single lens-composition lens structured in such a manner that at least, a lens part formed of the material (high dispersion material) of Abbe number vd for d-line is 20≦vd≦40, and a lens part formed of the material (low dispersion material) of Abbe number vd for d-line is 40≦vd≦70, are laminated in the optical axis direction, and the phase structure is formed on the boundary surface between a lens part formed of the material of Abbe number vd for d-line is 20≦vd≦40, and the air.

Then, in the case where the design work is conducted so that the light flux of wavelength λ1 transmits this diffractive structure, that is, the phase difference is not substantially given to the transmission light flux of wavelength λ1, when the depth in the optical axis direction of respective step difference of a plurality of step differences constituting each pattern of the phase structure is d1, the refractive index in the wavelength λ1 (=407 nm) of the material A is n_{A407}, the refractive index in the wavelength λ1 (=407 nm) of the material B is n_{B407}, the refractive index in the wavelength λ2 (=785 nm) of the material A is n_{A785}, and the refractive index in the wavelength λ2 (=785 nm) of the material B is n_{B785}, and for example, when the diffractive structure is formed on the material surface of the normal dispersion (Abbe number vd, 40≦vd≦70), in the case where the design work is conducted so that the light flux of wavelength λ1 transmits this diffractive structure, that is, the phase difference is not substantially given to the transmission light flux of wavelength λ1, the following expression (53)
d1(n_{A407}−n_{B497})=d1(1−n_{B407})≈407×N2
is given, where N2 is the natural number.

Then, when the light flux of wavelength λ2 is incident on the such designed diffractive structure, the expression (54)
d1(n_{A407}−n_{B785})=d1(1−n_{B785})≠785×N3
is realized, where N3 is the natural number.

When the compound optical element has been structured as described above, the ratio of the difference (n_{A407}-n_{B407})/(n_{A785}−n_{B785}) in the refractive index between the materials A and B, with respect to each wavelength is sufficiently removed from “1” due to different dispersion, as compared with the ratio of the wavelength of the incoming light flux (407:785≈1:2). Accordingly, the left-hand member of the expression (53) is different from that of the expression (54). Thus, a desired difference in diffraction angle can be provided for the light of wavelengths λ1 and λ3 by use of ½ of the natural number N2, hence by free selection of a combination of dispersion as the value N3 to be multiplied by 785, a value on the right-hand member of expression (54). As a result, arbitral diffraction angle difference can be given to the light flux with the wavelength k1 and the light flux with the wavelength λ2 by being selected a combination of the dispersions freely.

Herein, The same advantages can be obtained by utilizing an anomalous dispersion material, instead of a high dispersion material.

For example, even when the compound optical element is formed of high dispersion materials alone, spherical aberration is caused in response to a change in the oscillation wavelength resulting from the individual difference of the laser as a light source. However, the single lens of the present invention is based on a combination between the low- and high-dispersion materials, and the phase structure is formed on the surface of the high dispersion material. This structure reduces the amount of the spherical aberration despite a change in the oscillation wavelength resulting from the individual difference of the laser. Furthermore, for the first and third information recording medium as well as for the DVD as a second information recording medium (to be described later), this objective optical system can be used as a triple-compatible objective optical system.

Even when resin has been selected as well as when glass has been chosen as a low-dispersion material, the objective optical system according to the present invention is formed of a lamination of at least two layers having different Abbe numbers. Accordingly, this system has a greater number of the boundary surfaces (refractive surfaces) than a single lens composed of one type of optical material. The spherical aberration at the time of temperature variation, for example, can be corrected by providing these boundary surfaces with diffractive structures.

The following describes the laminated lens manufacturing method: When an ultraviolet curing resin is used as the high-dispersion material, it can be easily manufactured by pouring resin directly poured onto a low-dispersion material or by applying light when a lens composed of molded low-dispersion material is pressed onto the resin in the liquid state. When resin is used as the low-dispersion material, a diffractive structure can be provided on the boundary surface between the low- and high-dispersion materials.

In the present specification, DVD (Digital Versatile Disc) is a generic name of optical discs in a DVD series including DVD-ROM, DVD-Video, DVD-Audio, DVD-RAM, DVD-R, DVD-RW, DVD+R and DVD+RW, while, CD (Compact Disc) is a generic name of optical discs in a CD series including CD-ROM, CD-Audio, CD-Video, CD-R and CD-RW.

In this specification, the “objective optical element” is arranged so as to face the optical information recording medium in an optical pickup apparatus, and is defined as an optical system provided with two or more lenses including a light converging optical element having a function to converge a light flux emitted from a light source on the information recording surface of an optical disc.

Further, in the present specification, a light converging optical element corresponds to members, for example, such as the objective lens, coupling lens, beam expander, beam shaper, correction plate, which compose the light-converging optical system of the optical pickup apparatus.

Further, the objective lens is not limited only to a lens composed of a single lens, but it may also be an optical element in which lens groups composed by combining a plurality of lenses along the optical axis 1, are collected.

The above-described phase structure may be any one of the diffractive structure or the optical path difference providing structure. As the diffractive structure, there is the following structures: as typically shown in FIGS. 3(a) and 3(b), the structure (diffractive structure DOE) which is structured by a plurality of ring-shaped zones 100 and whose sectional shape including the optical axis is the serrated shape, or as typically shown in FIGS. 4(a) and 4(b), the structure (diffractive structure DOE) which is structured by a plurality of ring-shaped zones 102 whose direction of the step difference 101 is the same in the effective diameter, and whose cross sectional shape including the optical axis is the stepped shape, or as typically shown in FIGS. 6(a) and 6(b), the structure (diffractive structure DOE) which is structured by a plurality of ring-shaped zones 105 whose direction of the step difference 104 is switched on the mid-way of the effective diameter, and whose cross sectional shape including the optical axis is the stepped shape, or as typically shown in FIGS. 5(a) and 5(b), the structure (diffractive structure HOE) which is structured by a plurality of ring-shaped zones 103 inside of which the step structure is formed. Further, as the optical path difference providing structure, there is a structure (NPS), as typically shown in FIGS. 6(a) and 6(b), which is structured by a plurality of ring-shaped zones 105 whose direction of the step difference 104 is switched on the mid-way of the effective diameter and whose cross sectional shape including the optical axis is the stepped shape. Hereupon, FIG. 4(a) to FIG. 6(b) typically show a case where each phase structure is formed on the plane, however, each phase structure may also be formed on the spherical surface or aspherical surface. Further, in any one of the diffractive structure or the optical path difference providing structure, there is a case where it becomes the structure as typically shown in FIGS. 6(a) and 6(b).

Further, as shown in FIG. 16, in the case where the compound optical element is privided in such a manner that a plurality of materials which satisfy that Abbe number vd for d-line is 20≦vd<40 (for example, 2 kinds of materials which are a material α1 whose Abbe number vd=20, and a material α2 whose Abbe number vd=30), and a material whose Abbe number vd for d-line is 40≦vd≦70 (for example, a material β whose Abbe number vd=50) are laminated in order of α1, β, α2 in the optical axis direction from the light source side, a part combined with a part composed of material α1 and a part composed of material α2 corresponds to “lens part formed of a material having an Abbe number vd for d-line is 20≦vd<40” and a part composed of material β corresponds to “lens part comprising a material with an Abbe number vd for d-line is 40≦vd<70”.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a main part plan view showing a structure of an optical pickup apparatus;

FIG. 2 is a main part sectional view showing a structure of an objective lens;

FIGS. 3 (a), 3(b) are side views showing an example of an optical path difference providing structure;

FIGS. 4 (a), 4(b) are side views showing an example of an optical path difference providing structure;

FIGS. 5 (a), 5(b) are side views showing an example of an optical path difference providing structure;

FIGS. 6 (a), 6(b) are side views showing an example of an optical path difference providing structure;

FIG. 7 is a main part sectional view showing a composition of the objective lens in an example;

FIG. 8 is a vertical spherical aberration view when the objective lens in the example is used;

FIG. 9 is a vertical-spherical aberration view when the objective lens in the comparative example is used;

FIG. 10 is a main part sectional view showing the composition of the objective lens in the example;

FIG. 11 is a vertical spherical aberration view when the objective lens in the example is used;

FIG. 12 is a vertical spherical aberration view when the objective lens in the comparative example is used;

FIG. 13 is a main part plan view showing the structure of the optical pickup apparatus;

FIG. 14 is a main part plan view showing a structure of an objective optical element;

FIG. 15 is a main part plan view showing the structure of the objective optical element;

FIG. 16 is a main part plan view for explaining a lens part;

FIG. 17 is a main part plan view showing a structure of an objective optical element in the example;

FIG. 18 is a main part plan view showing the structure of the objective optical element in the example;

FIG. 19 is a main part plan view showing the structure of the objective optical element in the example;

FIG. 20 is a main part plan view showing the structure of the objective optical element in the example; and

FIG. 21 is a main part plan view showing the structure of the objective optical element in the example.

### DETAILED DESCRIPTION OF THE INVENTION

The proffered embodiments of the present invention are described below.

The structure written in item 2, according to a compound optical element written in item 1, is the compound optical element arranged in an optical path of a light flux with a wavelength λ1 (390 nm≦λ1≦420 nm) for reproducing and recording information on an optical information recording medium with a necessary numerical aperture of 0.8 or more in the optical pickup apparatus. When the compound optical element is arranged in an optical path of the light flux, the structure written in item 2 satisfies the expression (2),

Where t′(μm) is a thickness of the resin layer on the edge of the effective diameter,
t(μm) is a thickness of the resin layer on the optical axis, and
each of t and t′ is a length of a line segment from a first point where the light flux with the wavelength λ1 intersects a surface of the resin layer, to a second point where a line segment starting from the first point and running parallel to the optical axis intersects a boundary between the resin layer and the aspherical lens.
   0.9≦t′/t≦2.5 (2)

The structure written in item 3, according to the compound optical element written in item 2, converges the light flux with the wavelength λ1 and at least one light flux with a wavelength being different from the wavelength λ1 on respective information recording surfaces of different optical information recording media.

The thickness t and t′ of the resin layer on which the diffractive structure is provided, are different from the optical path length (L and L′) in the using condition, and are determined for adequately conducting the aberration correction of the light flux of wavelength λ1 which passed the necessary numerical aperture. As in item 2, when t′/t is within the expression (2), the aberration deterioration due to the difference of optical path length can be suppressed to the minimum, and can be used as the objective lens for optical pickup apparatus which records and reproduces HD.

The structure written in item 4 according to the compound optical element written in item 1, is the compound optical element when the compound optical element arranged in an optical path of a light flux with a wavelength λ1 (390 nm≦λ1≦420 nm) for reproducing and recording information on an optical information recording medium with a necessary numerical aperture of 0.6 or more in the optical pickup apparatus. When the light flux with a wavelength λ1 passes through the resin layer, the structure written in item 3 satisfies the expression (3), where t′(μm) is a thickness of the resin layer on the edge of the effective diameter,
t(μm) is a thickness of the resin layer on the optical axis, and
each of t and t′ is a length of a line segment from a first point where the light flux with the wavelength λ1 intersects a surface of the resin layer, to a second point where a line segment starting from the first point and running parallel to the optical axis intersects a boundary between the resin layer and the aspherical lens.
   1.0≦t′/t≦2.0 (3)

The thickness t and t′ of the resin layer on which the diffractive structure is provided, are different from the optical path length (L and L′) in the using condition, and are determined for adequately conducting the aberration correction of the light flux of wavelength λ1 which passed the necessary numerical aperture. As in item 3, when t′/t is within the expression (3), the aberration deterioration due to the difference of optical path length can be suppressed to the minimum, and can be used as the objective lens for the optical pickup apparatus which records and reproduces HD.

The structure written in item 5, according to the compound optical element written in item 4, converges the light flux with the wavelength λ1 and at least one light flux with a wavelength being different from the wavelength λ1 on respective information recording surfaces of different optical information recording media.

According to the structures written in items 3 and 5, the compatibility can be attained between the high density optical disc using the light flux of the wavelength λ1 and the other optical disc (for example, DVD or CD) using at least one light flux whose wavelength is different.

As for the structure written in item 6, in the compound optical element written in any one in items 1-5, the resin is an ultraviolet curing resin.

As in item 6, when the ultraviolet ray curing type material is used for the resin, the resin layer does not occur the chemical change in the wavelength range (390 nm-800 nm) used for a general optical information recording medium, but occurs the irreversible change in the wavelength of the ultraviolet ray and can be hardened.

In the compound optical element written in any one of item 1-6, when the refractive index to the wavelength λ1 of the aspherical surface lens is n1, and the refractive index to the wavelength λ1 of the resin after the hardening is n2, the structure written in item 7 satisfies the expression (4).
(n1/n2)≦1.2 (4)

When a ratio of the refractive index n1/n2 of the glass lens of the aspherical surface which is a base of the compound optical element, and the resin is larger than the upper limit, the refractive index variation due to the temperature change becomes large, and as the result, the spherical aberration is increased.

As for the structure written in item 8, in the compound optical element written in any one of items 1-7, the thickness t(μm) on the optical axis of the resin layer satisfies the expression (5).
10≦t≦1000 (5)

As in item 8, it is preferable that the necessary thickness of t for correcting the chromatic aberration using the phase structure or the aberration due to the wavelength difference of the using wavelength is more than 10 μm, and on the one hand, when t is more than 1000 μm, because the spherical aberration due to the refractive index change of the resin when the environmental temperature is changed, is generated, it is preferable that t is within 1000 μm.

As for the structure written in item 9, in the compound optical element written in any one of item 1-8, the lens of the aspherical surface is made of plastic.

When a resin layer is formed of the material whose Abbe number is around 30, as in item 9, for example, when the plastic lens whose Abbe number is around 60 are combined to the resin layer, the diffraction efficiency can be increased when the compatibility among several optical discs are attained by using the resin layer and the plastic lens. In this case, although the spherical aberration deterioration due to the temperature change becomes low than a case where the aspherical surface lens is formed of glass, it can be suppressed lower than the Marechal limit.

As for the structure written in item 10, in the compound optical element written in any one of items 1-8, the aspherical surface lens is made of glass.

As in item 10, even when it is a high NA compound optical element, when it is formed of glass, because a change amount of the refractive index change due to the temperature change is small, the spherical aberration deterioration can be suppressed.

As for the structure written in item 11, in the compound optical element written in item 10, the aspherical surface lens is a molded glass lens.

As in item 11, when the aspherical surface lens is manufactured by the glass molding, the aspherical surface shape can be easily made in a shorter time than a polished or ground lens.

The structure written in item 12 is, in the compound optical element written in any one of items 1-11, an objective lens for the optical pickup apparatus.

In the compound optical element written in any one of items 1-12, the optical pickup apparatus is provided with an objective lens including two or more optical elements and the structure written in item 13 is one of the two or more optical elements. In other words, the structure written in item 13 is a part of the objective lens in which 2 or more optical elements are combined.

As for the structure written in item 14, in the compound optical element written in any one of items 1-13, the resin layer is formed on each of an incident surface and an emerging surface of the aspherical lens.

The structure written in item 15 is an optical pickup apparatus provided with a light source and an objective lens for converging a light flux emitted by the light source on an information recording surface of an optical information recording medium, including the compound optical element of any one of items 1-14.

As for the structure written in item 17, in the compound optical element written in item 16, the phase structure is a diffractive structure.

According to the structure written in item 17, when the diffractive action is given to the passing light flux by the diffractive structure, the projecting direction of the ray of light can be changed.

As for the structure written in item 18, in the compound optical element written in item 17, the diffractive structure is provided with a plurality of patterns arranged concentrically and each of the plurality of patterns has a cross section including an optical axis with a stepped shape.

According to the structure written in item 18, for example, so-called wavelength selectivity that the light flux of wavelength λ1 incident on the diffractive structure is not diffracted, but only the light flux of wavelength λ2 is diffracted, can be given.

Further, because the structure transmits the light of wavelength λ1, the light amount lowering by the effect of the shadow of the diffraction can be reduced. Further, by providing the diffractive action to only the light of wavelength λ2, the diffraction direction of the light can be entirely individually set to the light of wavelengths λ1 and λ2.

As for the structure written in item 19, in the compound optical element written in item 18, the diffractive structure is provided with a plurality of ring-shaped zones arranged concentrically around an optical axis and each of the plurality of ring-shaped zones has a sectional shape including the optical axis with a serrated shape.

As for the structure written in item 20, in the compound optical element written in item 19, the diffractive structure corrects a chromatic aberration for the light flux with the wavelength λ1.

According to the structure written in item 20, because both light of wavelengths λ1 and λ2 are diffracted, the diffraction effect is given to both light fluxes, and while the chromatic correction action is given to the light of wavelength λ1, the spherical aberration for the compatibility can be corrected for the light of wavelength λ2, which is difficult, for example, in the wavelength selection type diffractive structure. Further, when the step of the diffractive structure is designed always in the same direction to the optical axis, the workability of the diffractive structure can be improved.

As for the structure written in item 21, in the compound optical element written in any one of item 16-19, the compound optical element consists of a first lens part including the material with an Abbe number vd for the d-line of 20≦vd<40, and a second lens part including a material with an Abbe number vd for the d-line of 40≦vd≦70, and a volumetric ratio of the material with Abbe number vd for the d-line is 20≦vd<40 to the whole body of the compound optical element is 20% or less.

In the high dispersion material, there are many materials having double refraction, and even when such a material is used, according to the structure written in item 21, when the volumetric ratio to the whole body is suppressed, the influence of birefringence can also be reduced.

As for the structure written in item 22, in the compound optical element written in any one of item 16-19, the compound optical element consists of a first lens part formed of a material with an Abbe number vd for d-line of 20≦vd<40, and a second lens part formed of a material with an Abbe number vd for d-line of 40≦vd≦70, and a first lens part formed of the material with the Abbe number vd for d-line is 20≦vd<40, is positioned at the most light source side in the compound optical element.

According to the structure written in item 22, when a lens part formed of a material with an Abbe number vd for d-line is 20≦vd<40, having the phase structure is positioned at the most light source side, the design work of the compound optical element whose curvature of the optical surface on the light source side is made small, can be conducted. Further, because, on the optical surface on the light source side rather than on the optical information recording medium side, an angle to the optical axis of the incident and projecting direction of the light flux is small, the light amount lowering due to the effect of shadow to the light of wavelength λ1 can be reduced.

In the compound optical element written in any one of item 16-19, the structure written in item 23 satisfies
1.8×t1≦t2≦2.2×t1.

As for the structure written in item 24, in the compound optical element written in any one of item 16-19, the phase structure is formed on an area which transmits a light flux with the wavelength λ2, used for reproducing and/or recording information on the second optical information recording medium, and is not formed on an area which does not transmit the light flux with the wavelength λ2, used for reproducing and/or recording information on the second optical information recording medium.

According to the structure written in item 24, there is no case where the phase structure is provided on unnecessary area and the light amount is needlessly lowered, further, when, to the light of wavelength λ2, the shape of the phase structure is differed based on an area necessary for recording and/or reproducing and an area unnecessary for that, the aperture limit function can be given.

As for the structure written in item 25, in the compound optical element written in any one of item 16-24, the optical pickup apparatus further reproduces and/or records information by using a light flux with a wavelength λ3 (λ1<k3<λ2) emitted from a third light source on the third optical information recording medium having a protective substrate with a thickness t3 (0.9 μl≦t3≦t2).

As for the structure written in item 26, in the compound optical element written in item 25, the phase structure corrects a chromatic spherical aberration due to a wavelength difference between the light flux with the wavelength λ1 and the light flux with the wavelength λ3.

According to the structure written in item 26, because only the spherical aberration generated by the wavelength difference is corrected, the compatibility between the optical information recording media only whose wavelengths are different, such as HD DVD and DVD, can be attained.

As for the structure written in item 27, in the compound optical element written in item 25, the optical system magnifications m2 and m3 of the compound optical element for the light fluxes with the wavelengths λ2 and λ3 respectively satisfy −1/10≦m2≦1/10 and −1/12≦m3≦1/12.

The structure written in item 28 is an optical pickup apparatus-provided with a first light source for emitting a first light flux with a wavelength λ1 for reproducing and/or recording information on a first optical disc having a protective substrate with a thickness t1; a second light source for emitting a second light flux with a wavelength λ2 (1.8×λ1≦λ2≦2.2×λ1) for reproducing and/or recording information on a second optical disc having a protective substrate with a thickness t2 (1.7×t1≦t2); and a objective lens for converging the first light flux and the second light flux on the information recording surfaces of the first and second optical information recording media, respectively, including the compound optical written in any one of items 16-27.

The structure written in item 29 according to the optical pickup apparatus of item 29 is further provided with a third light source for emitting a third light flux with a wavelength λ3 (λ1<λ3<λ2) for reproducing and/or recording information on a first optical disc having a protective substrate with a thickness t3 (0.9×t1≦t3≦t2).

According to the present invention, the compound optical element which is low cost and by which the man-hour of the adjusting operation at the time of assembly can be reduced, and the optical pickup apparatus having this compound optical element can be obtained.

Further, according to the present invention, for the purpose that the compatibility between the high density optical disc and CD whose ratio of wavelength of the using light fluxes are about 1:2, is attained, the compound optical element by which these two light fluxes can be respectively projected at different angle by using the diffractive structure, and the optical pickup apparatus mounted this compound optical element, can be obtained.

### EXAMPLES

### The First Embodiment

Referring to the drawings, the present invention will be detailed below.

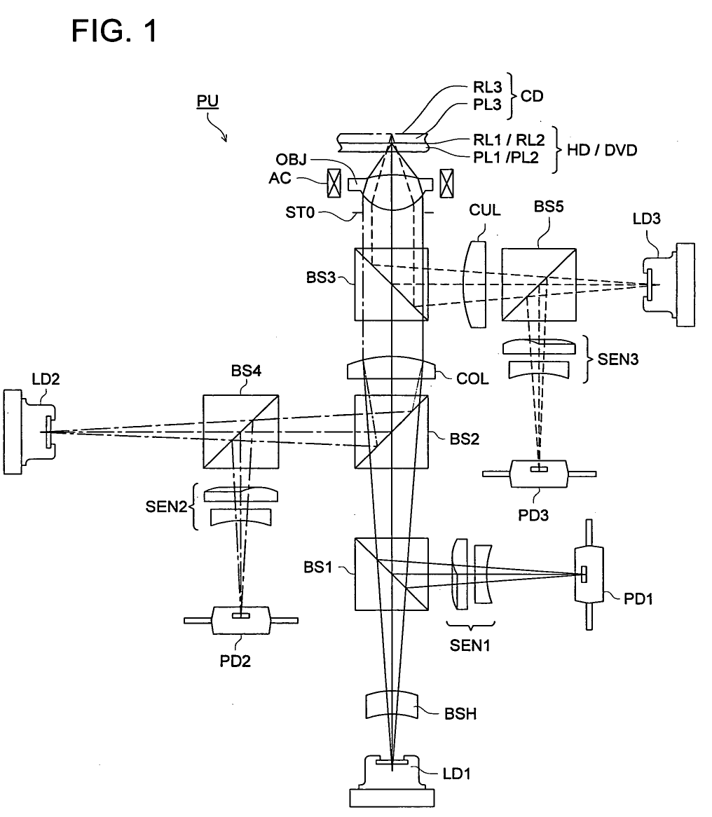

FIG. 1 is a view schematically showing a structure of an optical pickup apparatus by which the recording/reproducing of the information can be adequately conducted on any one of HD (the first optical disc), DVD (the second disc) and CD (the third disc). The optical specification of HD is, wavelength λ1=407 nm, the thickness t1 of the protective layer (protective substrate) PL1=0.6 mm, numerical aperture NA1=0.65, the optical specification of DVD is, wavelength λ2=655 nm, the thickness t2 of the protective layer PL2=0.6 mm, numerical aperture NA2=0.65, and the optical specification of CD is, wavelength λ3=785 nm, the thickness t3 of the protective layer PL3=1.2 mm, numerical aperture NA3=0.51. However, a combination of the wavelength, thickness of the protective layer, and numerical aperture is not limited to this.

Further, when the recording and/or reproducing of the information is conducted on the first optical disc, the optical system magnification m1 of the objective lens OBJ (compound optical element) is m1=0. That is, in the objective lens OBJ in the present embodiment, it is a structure on which the first light flux of wavelength λ1 is incident as the parallel light.

Further, when the recording and/or reproducing of the information is conducted on the second optical disc, the optical system magnification m2 of the objective lens OBJ is also in the same manner, m2=0. That is, in the objective lens OBJ in the present embodiment, it is a structure on which the second light flux of wavelength λ2 is incident as the parallel light.

Further, when the recording and/or reproducing of the information is conducted on the third optical disc, the optical system magnification m3 of the objective lens OBJ is m3<0. That is, in the objective lens OBJ in the present embodiment, it is a structure of finite conjugate system on which the third light flux of wavelength λ3 is incident as the divergent light. Hereupon, in the present invention, a combination of m1, m2 and m3 can be appropriately changed.

The optical pickup apparatus PU is provided with: a blue violet semiconductor laser LD1 (the first light source) projecting the laser light flux (the first light flux) of 407 nm which is emitted when the recording/reproducing of the information is conducted on HD; a photo detector PD1 for the first light flux; a red semiconductor laser LD2 (the second light source) projecting the laser light flux (the second light flux) of 655 nm which is emitted when the recording/reproducing of the information is conducted on DVD; a photo detector PD2 for the second light flux; a infrared semiconductor laser LD3 (the third light source) projecting the laser light flux (the third light flux) of 785 nm which is light-emitted when the recording/reproducing of the information is conducted on CD; a photo detector PD3 for the third light flux; a collimator lens COL through which the first light flux and the second light flux pass; a coupling lens CUL through which the third light flux passes; an objective lens OBJ on whose optical surface the diffractive structure is formed, and both surfaces of which are aspherical surfaces having a function by which each of light fluxes is light-converged on the information recording surfaces RL1, RL2, and RL3; a 2-axis actuator AC which moves the objective lens OBJ in the predetermined direction; the first—fifth beam splitters BS1-BS5, a beam shaper BSH; a stop STO; sensor lenses SEN1-SEN3.

In the optical pickup apparatus PU, when the recording/reproducing of the information is conducted on HD, as its ray of light path is drawn by a solid line in FIG. 1, initially, the blue violet semiconductor laser LD1 is light-emitted. The sectional shape of the divergent light flux projected from the blue violet semiconductor laser LD1 is changed when the light flux passes the beam shaper BSH, and the light flux passes the first beam splitter BS1 and the second beam splitter BS2, and reaches the collimator lens COL.

Then, the first light flux is converted into the parallel light when the light flux passes the collimator lens COL, passes the third beam splitter BS3, the stop STO, reaches the objective lens OBJ, and becomes a spot formed on the information recording surface RL1 through the first protective layer PL1 by the objective lens OBJ. The objective lens OBJ conducts the focusing or tracking by the 2-axis actuator AC arranged in its periphery.

The reflected light flux modulated by the information pit on the information recording surface RL1, passes again the objective lens OBJ, the third beam splitter BS3, collimator lens COL, the second beam splitter BS2, branched by the first beam splitter BS1, the astigmatism is given by the sensor lens SEN1, and the light flux is converged on the light receiving surface of the photo detector PD1. Then, by using the output signal of the photo detector PD1, the information recorded in HD can be read.

Further, when the recording/reproducing of the information is conducted on DVD, as its ray of light path is drawn by a one-dotted chain line in FIG. 1, initially, the red semiconductor laser LD2 is light-emitted. The divergent light flux projected from the red semiconductor laser LD2 passes the fourth beam splitter BS4 and is reflected by the second beam splitter BS2, and reaches the collimator lens COL.

Then, the second light flux is converted into the parallel light when the light flux passes the collimator lens COL, passes the third beam splitter BS3, the stop STO, reaches the objective lens OBJ, and becomes a spot formed on the information recording surface RL2 through the second protective layer PL2 by the objective lens OBJ. The objective lens OBJ conducts the focusing or tracking by the 2-axis actuator AC arranged in its periphery.

The reflected light flux modulated by the information pit on the information recording surface RL2, passes again the objective lens OBJ, the third beam splitter BS3, collimator lens COL, and is branched by the second beam splitter BS2, further, branched by the fourth beam splitter BS4, the astigmatism is given by the sensor lens SEN2, and the light flux is converged on the light receiving surface of the photo detector PD2. Then, by using the output signal of the photo detector PD2, the information recorded in DVD can be read.

Further, when the recording/reproducing of the information is conducted on CD, as its ray of light path is drawn by a dotted line in FIG. 1, initially, the infrared semiconductor laser LD3 is emitted. The divergent light flux projected from the infrared semiconductor laser LD3 passes the fifth beam splitter BS5 and reaches the coupling lens CUL.

Then, the divergent angle of the third light flux is converted when the light flux passes the coupling lens CUL, reflected by the third beam splitter BS3, passes the stop STO, reaches the objective lens OBJ, and becomes a spot formed on the information recording surface RL3 through the third protective layer PL3 by the objective lens OBJ. The objective lens OBJ conducts the focusing or tracking by the 2-axis actuator AC arranged in its periphery.

The reflected light flux modulated by the information pit on the information recording surface RL3, passes again the objective lens OBJ, is reflected by the third beam splitter BS3, passes the coupling lens CUL, and is branched by the fifth beam splitter BS5, the astigmatism is given by the sensor lens SEN3, and the light flux is converged on the light receiving surface of the photo detector PD3. Then, by using the output signal of the photo detector PD3, the information recorded in CD can be read.

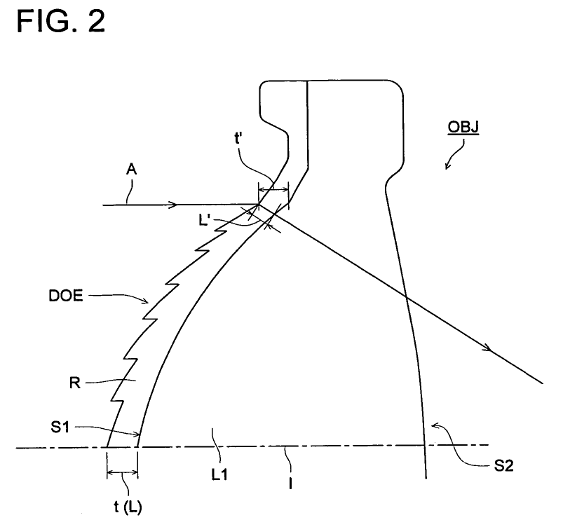

Next, the structure of the objective lens OBJ will be described. As shown in FIG. 2, the objective lens OBJ is a structure having a resin layer R formed of a ultraviolet curing resin on the incident surface S1 of the glass mold lens L1 of the single lens which is composed of a lens whose both surfaces of the incident surface S1 (optical surface on the light source side) and the projecting surface S2 (optical surface on the optical disc side) are aspherical surfaces.

Hereupon, not limited to only the ultraviolet curing resin, the resin layer R may also be formed of the thermal plastic resin by an insert molding (by flowing the resin between the metallic mold and the glass mold lens L1).

Further, the optical path difference providing structure (phase structure) is formed on an area which is the surface of the resin layer R and which corresponds to the numerical aperture NA1. In the present embodiment, as the optical path difference providing structure, the diffractive structure DOE whose sectional view including the optical axis is saw-serrated is formed.

Further, the optical surface S2 of the objective lens OBJ is formed of the refractive surface.

Then, it is set so that a ratio of the optical path length L′ of the end of the effective diameter corresponding to the necessary numerical aperture (NA1) when the light flux A of wavelength λ1 passes the resin layer R, and the optical path length L, satisfies the expression (1).
0.8≦(L′/L)≦1.2 (1)

Hereupon, L and L′ equal to values L/n2 and L′/n2 in which L and L′ in FIG. 2 are divided by the refractive index n2 to the wavelength λ1 of the resin layer R.

When L′/L is made within the above-described rang e, the chromatic aberration correction by using the diffractive structure DOE provided on the resin layer R, the correction of the spherical aberration due to the refractive index change of the resin layer R by a change of the environmental temperature, and the correction of the coma when the off-axial light is incident on the objective lens OBJ, can be adequately conducted.

When L′/L is smaller than the lower limit, the correction of chromatic aberration becomes insufficient, and when L′/L is larger than the upper limit, the correction of the spherical aberration when the environmental temperature is changed, or the correction of the coma generation becomes insufficient.

Further, in the present embodiment, when the thickness of a part of the end of the effective diameter corresponding to the necessary numerical aperture (NA1) of the resin layer R when the light flux of wavelength λ1 passes the resin layer R, is t′(μm) and the thickness on the optical axis 1 is t (μm), it is set so as to satisfy the expression (2).
0.9≦t′/t≦2.5 (2)

Herein, t and t′ indicate the length of a line segment from a point at which the light flux of wavelength λ1 crosses the surface of the resin layer R to a point at which the straight line drawn in parallel to the optical axis 1 crosses the boundary surface between the resin layer R and lens L1.

The thickness t and t′ of the resin layer R on which the diffractive structure DOE is provided are different from the optical path length (the above-described L and L′) in the using condition, and are determined to adequately conduct the aberration correction of the light flux of wavelength λ1 passed in the necessary numerical aperture. When t′/t is within the range of the expression (2), the aberration deterioration due to the difference of optical path length can be suppressed to the minimum, and it can be used as the objective lens for the optical pickup apparatus which records and reproduces HD.

Hereupon, it is preferable that the thickness t (μm) on the optical axis 1 of the resin layer R is within the range of the expression (5).
10≦t≦1000 (5)

It is preferable that the thickness necessary for t to correct the chromatic aberration by using the diffractive structure DOE as described above, or the aberration due to the wavelength difference of using wavelength, is not smaller than 10 μm. On the one hand, when t is larger than 1000 μm, because the spherical aberration is generated by the refractive index change of resin when the environmental temperature is changed, it is preferable that t is within 1000 μm. Hereupon, it is more preferable that t is 50 μm-150 μm.

Further, when the refractive index to the wavelength λ1 of the lens is n1, the refractive index to the wavelength λ1 of the resin after hardening is n2, it is preferable to set so as to satisfy the expression (4).
(n1/n2)≦1.2 (4)

When a ratio of the refractive index n1/n2 of the aspherical surface glass lens L1 which is a base of the objective lens OBJ, and the resin R is larger than the upper limit, the refractive index variation due to the temperature change becomes large, as a result, the spherical aberration is increased. Hereupon, when the refractive index nd in d-line of the glass lens L1 is nd=1.61, it is desirable that the refractive index nd′ in d-line of the resin R is nd′=about 1.54.

Hereupon, in the present embodiment, the compound optical element according to the present invention is applied to the objective lens of a single lens, however, it is not limited to this, the present invention may also be applied to one lens of the objective lens in which a plurality of lenses are sequentially arranged along the direction of the optical axis 1. Further, the compound optical element according to the present invention may also be applied to the optical element other than the objective lens arranged in the optical path of the light flux with the wavelength λ1, for example, to the collimator lens.

Further, the resin layer R is formed only on the incident surface S1 of the lens L1 of the aspherical surface, however, it is not limited to this, it may also be formed, for example, only on the projecting surface S2, or on both of the incident surface S1 and the projecting surface S2.

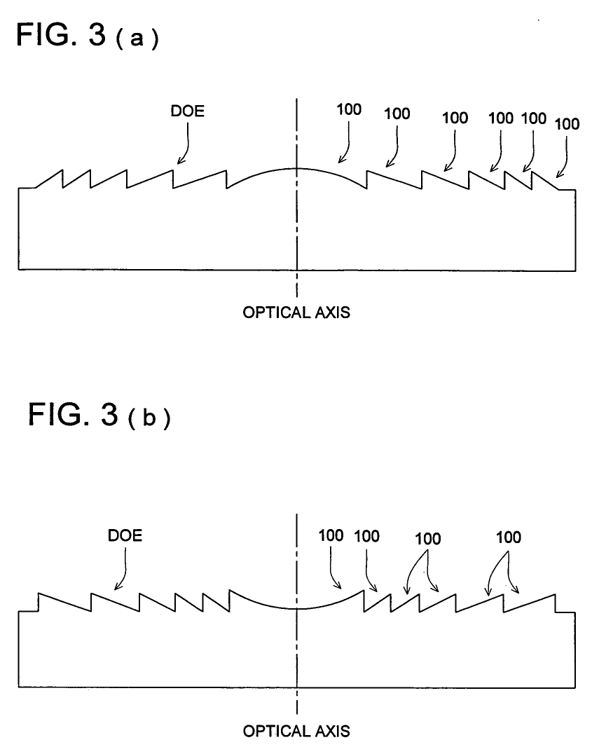

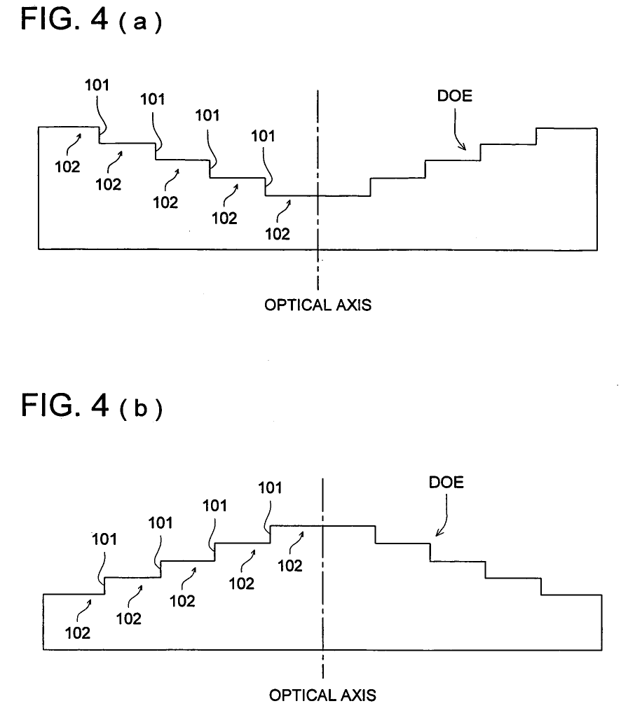

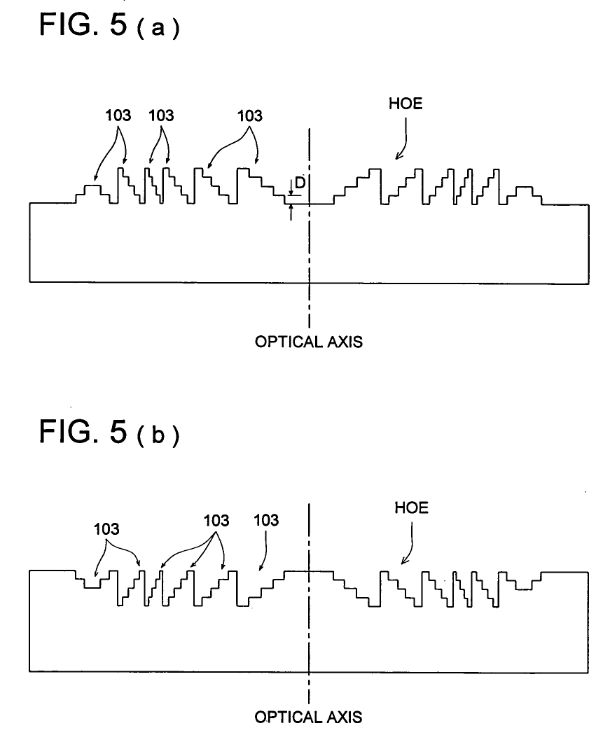

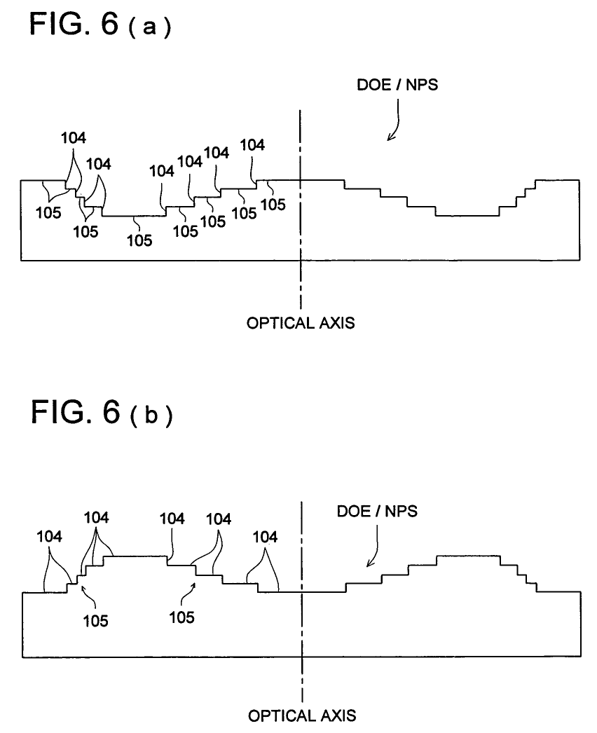

When a phase structure shown in FIGS. 3(a) to 6(b) is formed on the resin layer, for example, the spherical aberration in the case where the wavelength of the semiconductor laser is changed following the temperature change, can be suppressed, the spherical aberration in the case where the semiconductor laser whose oscillation wavelength is dislocated from the reference wavelength, is used, can be suppressed, or even when, by the mode hopping of the laser, the wavelength of the incident light flux is instantly changed, a good recording/reproducing characteristic can be maintained.

Further, by using the optical path difference providing structure provided in the objective lens OBJ, the chromatic aberration due to the wavelength difference between the first light flux of wavelength λ1 for HD and the second light flux of wavelength λ2 for DVD, and/or the spherical aberration due to the difference of the thickness between the protective layer of HD and the protective layer of DVD can be corrected. Hereupon, the chromatic aberration used herein, indicates the minimum position variation of the wavefront aberration in the optical axis direction due to the wavelength difference. For example, when the phase structure is made the diffractive structure which gives the positive diffraction action to at least one light flux of light fluxes of the wavelengths λ1 and λ2, the chromatic aberration generated due to the wavelength variation of the light flux to which the diffraction action is given, can be suppressed.

Further, as an aperture element to conduct the aperture limit corresponding to NA3, it may also be a structure in which the aperture limit element AP is arranged in the vicinity of the optical surface S1 of the objective lens OBJ, and the aperture limit element AP and the objective lens OBJ are integrally tracking driven, by the 2-axis actuator.

On the optical surface of the aperture limit element AP in this case, the wavelength selection filter WF having the wavelength selectivity of the transmission factor is formed. Because this wavelength selection filter WF makes all wavelengths of the first wavelength λ1 to the third wavelength ˜3 pass in the area of NA3, cut-off only the third wavelength λ3 in an area from NA3 to NA1, and has the wavelength selectivity of the transmission factor by which the first wavelength λ1 and the second wavelength λ2 are transmitted, by such a wavelength selectivity, the aperture limit corresponding to NA3 can be conducted.

Further, as a limitation method of the aperture, not only a method using the wavelength selection filter WF, but a method by which the stop is mechanically switched, or a method using a liquid crystal phase control element LCD, may also be allowable.

It is desirable that the objective lens OBJ is formed of plastic from the viewpoint of light weight and low cost, however, when considering the temperature resistance, light resistance, it may also be manufactured of glass. Presently, a refraction type glass mold aspherical surface lens is in the market, however, when a low melting point glass in which the development is advanced, is used, a glass mold lens in which the diffractive structure is provided, can also be manufactured. Further, while the development of the plastic for optical use, is also advanced, there is a material whose refractive index change due to the temperature is small. This is a material in which, when inorganic minute particles whose coincidence of the refractive index change due to the temperature is reversal, are mixed, the refractive index change due to the temperature, are mixed, the refractive index change due to the temperature of whole of resins is reduced, however, there is a material in which the dispersion of whole of resins is reduced when, in the same manner, inorganic minute particles whose dispersion is small, are mixed, and it is more effective when they are used for the objective lens for BD.

Further, the optical pickup apparatus PU in the present embodiment is the structure which has the compatibility among three kinds of optical discs of the high density optical disc (HD)/DVD/CD, however, not limited to this, it may be a structure which has only the blue violet semiconductor laser LD1, and which is exclusive for the high density optical disc, or it may also be a structure which has only the blue violet semiconductor laser LD1 and red semiconductor laser LD2, and has the compatibility between two kinds of optical discs of the high density optical disc/DVD.

### Example 1

Next, examples of the compound optical element shown in the above embodiment will be described.

The lens data of Example 1 is shown in Table 1.

TABLE 1
Example 1 lens data

| | |
|---|---|
| Focal distance of the objective lens | f = 1.77 mm |
| Image surface side numerical aperture | NA 0.85 |
| 2nd surface diffraction order | n: 1 |
| Refractive index of the aspherical lens | n1 = 1.62781 |
| for wavelength λ1 | |
| Refractive index of the aspherical lens | n2 = 1.56013 |
| for wavelength λ2 | |
| n1/n2 | 1.043381 |
| Optical path length of a light flux | L = 0.1 |
| enters into the compound optical element | |
| and passes the resin layer on an optical | |
| axis | |
| Optical path length of a light flux | L′ = 0.09539 |
| enters into the compound optical element | |
| and passes the resin layer on an edge of | |
| an effective diameter which corresponds | |
| to a necessary numerical aperture | |
| L′/L | 0.9539 |
| The thickness t′ of the resin layer at | 0.18 mm |
| the end of effective diameter | |

| The i-th | | di | ni |
|---|---|---|---|
| surface | ri | (405 nm) | (405 nm) |
| 0 | | ∞ | |
| 1 | ∞ | 0.01 | |
| (Stop diameter) | | (φ 3.01 mm) | |
| 2 | 1.32690 | 0.10 | 1.56013 |
| 3 | 1.24600 | 2.23 | 1.62781 |
| 4 | −2.91600 | 0.43400 | |
| 5 | ∞ | 0.085 | 1.61950 |
| 6 | ∞ | | |

Aspherical surface data
The 2nd surface
Aspherical surface coefficient
κ −4.50030E−01
A4 5.75350E−03
A6 −5.19273E−03
A8 1.20537E−02
A10 −1.13981E−02
A12 2.45682E−03
A14 4.43670E−03
A16 −4.12113E−03
A18 1.43523E−03
A20 −1.88613E−04
Optical path difference function
B2 4.72271E−03
B4 −2.70414E−03
B6 −4.36528E+01
B8 8.81881E−07
B10 −4.36521E+01
The 3rd surface
κ −6.56368E−01
A4 1.56300E−02
A6 −1.05523E−03
A8 1.04809E−02
A10 −1.00771E−02
A12 3.11417E−03
A14 4.01913E−03
A16 −4.42175E−03
A18 1.72631E−03
A20 −2.50911E−04
The 4th surface
Aspherical surface coefficient
κ −1.10914E+02
A4 1.75611E−01
A6 −2.91356E−01
A8 3.53414E−01
A10 −3.51433E−01
A12 2.08250E−01
A14 −5.17952E−02
*di expresses a dislocation from the ith surface to the (i + 1)th surface

As shown in Table 1, in the present example, the compound optical element of the present invention is applied to the objective lens.

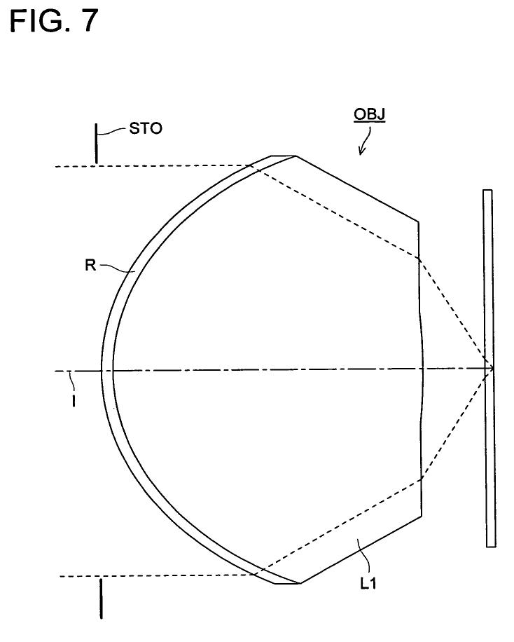

The objective lens OBJ of the present example shown in FIG. 7 is an exclusive use for BD, and is set to the focal distance f1=1.77 mm, and the image side numerical aperture NA=0.85.

The surface (2nd surface) of the resin layer R, the incident surface (optical surface on the light source side, the 3rd surface) of the lens L1, and the projecting surface (optical surface on the optical disc side, the 4th surface) are formed into aspherical surfaces which are regulated by an equation in which coefficients shown in Table 1 are substituted in the following expression (Math-1), and which are axially symmetric around the optical axis.

$$x = \frac{{h}^{2} / r}{1 + \sqrt{1 - ( 1 + κ )} {( h / r )}^{2}} + {\sum }_{i = 2} {A}_{2 i} {h}^{2 i} \qquad ( Math \text{-} 1 )$$

Herein, x is an axis in the optical axis direction (advancing direction of the light is positive), κ is conical coefficient, and A₂ᵢ is aspherical surface coefficient.

Further, the diffractive structure DOE (phase structure) of the 2nd surface is expressed by the optical path difference added to the transmission wavefront by this structure. Such an optical path difference is expressed by, when h (mm) is a height in the direction perpendicular to the optical axis, B2i is optical path difference coefficient, n is the diffraction order of the diffraction light having the maximum diffraction efficiency in the diffraction light of the incident light fluxes, λ(nm) is the wavelength of the light flux incident on the diffractive structure, λB (nm) is the manufacturing wavelength of the diffractive structure, the optical path difference function φ(h)(mm) defined by substituting coefficients shown in Table 1 into the following expression (Math-2).

Hereupon, the blaze wavelength λB of the diffractive structure DOE is 1.0 mm.

$$Optical path difference function \\ ϕ ( h ) = ( {\sum }_{i = 0}^{5} {B}_{2 i} {h}^{2 i} ) \times n \times λ / λ B \qquad ( Math \text{-} 2 )$$

Further, the thickness t′ at a part of the edge of the effective diameter of the resin layer R is set to t′=0.18 mm, and the thickness t on the optical axis is set to t=0.1 mm.

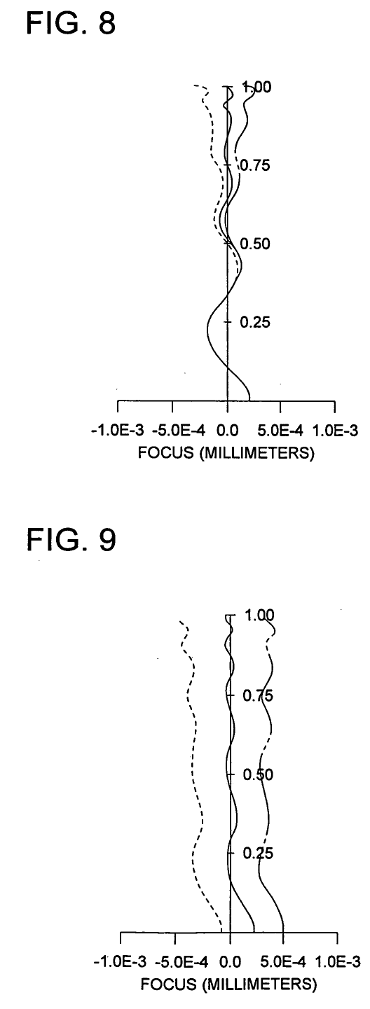

FIG. 8 is a vertical spherical aberration view when the wavelength λ1=405 nm is varied by ±1 nm, the horizontal axis shows a generation amount of the spherical aberration, and in the vertical axis, a position corresponding to NA=0.85 is 1.00. The line shown by a solid line in FIG. 8 indicates a case where the wavelength is 405 nm, the line shown by a dotted line indicates a case where the wavelength is 404 nm, and the line shown by a 2-dotted chain line indicates a case where the wavelength is 406 nm.

FIG. 9 is, as an comparative example, a vertical spherical aberration view when the resin layer R is removed from the objective lens OBJ shown in FIG. 7, and the objective lens in which the incident surface (the 3rd surface) and the projecting surface (the 4th surface) of the lens L1 are composed of the aspherical surfaces which are axially symmetric around the optical axis 1, and which are regulated by the equation in which coefficients shown in Table 1 are substituted into the above (Math-1), is used.

From FIGS. 8 and 9, it can be seen that, in the objective lens of the present example, because, even at the time of wavelength variation, the spherical aberration is suppressed within 0.1 μm/nm, when the objective lens is driven by the actuator, and follows the wavelength variation, the spherical aberration can be realized within Mareshall limit of 0.07 (λrms), however, in the objective lens of the comparative example, because at the time of wavelength variation, the spherical aberration exceeds 0.4 μm/nm, even in the case where the objective lens is driven by the actuator, the spherical aberration can not be realized within Mareshall limit of 0.07 (λrms).

### Example 2

Lens data of Example 2 is shown in Table 2.

TABLE 2
Example 2 lens data

| | |
|---|---|
| Focal distance of the objective lens | f = 1.75 mm |
| Image surface side numerical aperture | NA 0.65 |
| 2nd surface diffraction order | n: 3 |
| Refractive index of the aspherical lens | n1 = 1.627391 |
| for wavelength λ1 | |
| Refractive index of the aspherical lens | n2 = 1.55981 |
| for wavelength λ2 | |
| n1/n2 | 1.043326 |
| Optical path length of a light flux | L = 0.05 |
| enters into the compound optical element | |
| and passes the resin layer on an optical | |
| axis | |
| Optical path length of a light flux | L′ = 0.04057 |
| enters into the compound optical element | |
| and passes the resin layer on an edge of | |
| an effective diameter which corresponds | |
| to a necessary numerical aperture | |
| L′/L | 0.8114 |
| The thickness t′ of the resin layer at | 0.0057 mm |
| the end of effective diameter | |

| | | di | ni |
|---|---|---|---|
| The ith surface | ri | (407 nm) | (407 nm) |
| 0 | | ∞ | |
| 1 | ∞ | 0.01 | |
| (Stop diameter) | | (φ 3.01 mm) | |
| 2 | 1.26386 | 0.05 | 1.55981 |
| 3 | 1.25072 | 1.17 | 1.627391 |
| 4 | −9.72762 | 0.68257 | |
| 5 | ∞ | 0.6 | 1.61869 |
| 6 | ∞ | | |

Aspherical surface data
The 2nd surface
Aspherical surface coefficient
κ −5.26864E−01
A4 8.09942E−03
A6 −2.13358E−02
A8 1.35029E−02
A10 1.67451E−02
A12 −1.56429E−02
A14 3.32436E−03
Optical path difference function
B2 −1.49395E+01
B4 4.59333E+00
B6 −1.68755E+01
B8 1.21764E+01
B10 −3.29024E+00
The 3rd surface
Aspherical surface coefficient
κ −5.63917E−01
A4 8.01020E−02
A6 −2.14711E−02
A8 1.76475E−02
A10 1.58461E−02
A12 −1.68943E−02
A14 3.88567E−03
The 4th surface
Aspherical surface coefficient
κ −8.88888E+01
A4 −2.29662E−02
A6 2.01348E−01
A8 −1.51652E−01
A10 −1.60517E−01
A12 3.04314E−01
A14 −1.63042E−01
A16 2.84077E−02
*di expresses a dislocation from the ith surface to the (i + 1)th surface

As shown in Table 2, in the present example, the compound optical element of the present invention is applied for the objective lens.

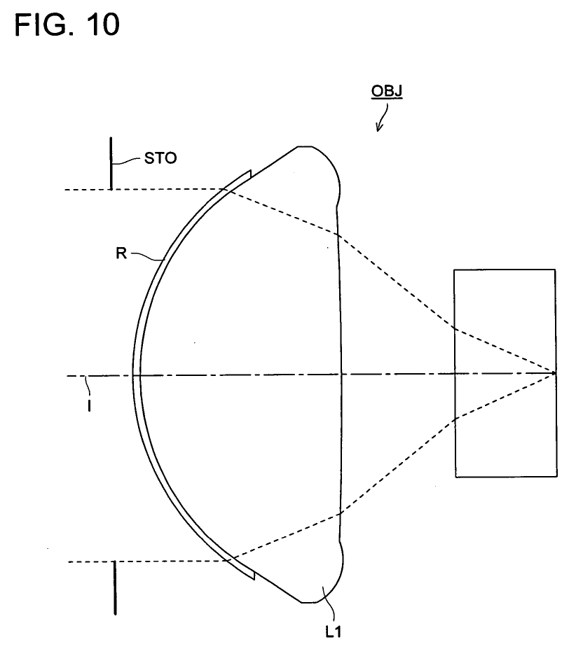

The objective lens OBJ of the present example shown in FIG. 10 is a lens for compatibility of HD/DVD/CD, and is set to focal distance f1=1.75 mm, and the image side numerical aperture NA=0.65. Further, although not written in Table 2, the thickness of the protective layer of DVD and CD are respectively 0.6 mm and 1.2 mm, the wavelength λ2 of the light flux for DVD=655 nm, and the wavelength λ3 of the light flux for CD=785 nm.

The surface (2nd surface) of the resin layer R, the incident surface (optical surface on the light source side, the 3rd surface) of the lens L1, and the projecting surface (optical surface on the optical disc side, the 4th surface) are formed into aspheric surfaces which are regulated by an equation in which coefficients shown in Table 2 are substituted in the above expression (Math-1), and which are axially symmetric around the optical axis.

Further, the diffractive structure DOE of the 2nd surface is expressed by the optical path difference added to the transmission wavefront by this structure. Such an optical path difference is expressed by the optical path difference function φ(h)(mm) defined by substituting coefficients shown in Table 2 into the above expression (Math-2).

Hereupon, the blaze wavelength λB of the diffractive structure DOE is 1.0 mm. Further, it is set to the thickness t′ at a part of the end of the effective diameter of the resin layer R=0.057 mm, the thickness on the optical axis t=0.05 mm.

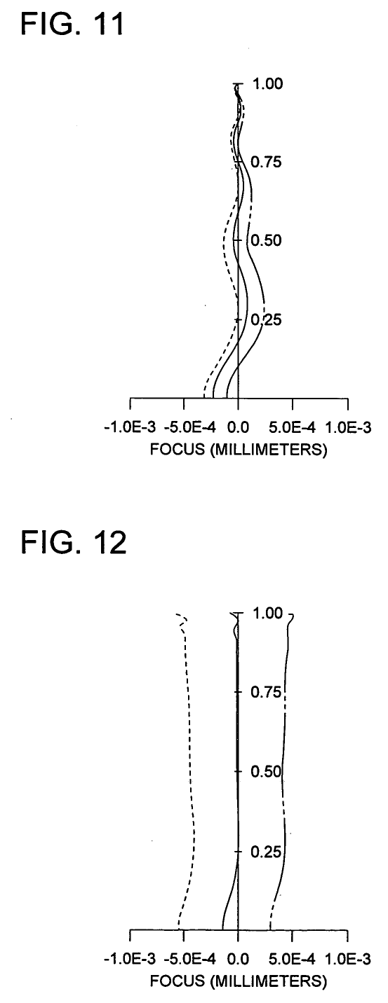

FIG. 11 is a vertical spherical aberration view when the wavelength λ1=407 nm is varied by ±1 nm, the horizontal axis shows a generation amount of the spherical aberration, and in the vertical axis, a position corresponding to NA=0.85 is 1.00. The line shown by a solid line in FIG. 11 indicates a case where the wavelength is 407 nm, the line shown by a dotted line indicates a case where the wavelength is 406 nm, and the line shown by a 2-dotted chain line indicates a case where the wavelength is 408 nm.

FIG. 12 is, as an comparative example, a vertical spherical aberration view when the resin layer R is removed from the objective lens OBJ shown in FIG. 10, and the objective lens in which the incident surface (the 3rd surface) and the projecting surface (the 4th surface) of the lens L1 are composed of the aspheric surfaces which are axially symmetric around the optical axis 1, and which are regulated by the equation in which coefficients shown in Table 2 are substituted into the above (Math-1), is used.

From FIGS. 11 and 12, it can be seen that, in the objective lens of the present example, because, even at the time of wavelength variation, the spherical aberration is suppressed within 0.1 μm/nm, when the objective lens is driven by the actuator, and follows the wavelength variation, the spherical aberration can be realized within Mareshall limit of 0.07 (αrms), however, in the objective lens of the comparative example, because, at the time of wavelength variation, the spherical aberration exceeds 0.4 μm/nm, even in the case where the objective lens is driven by the actuator, the spherical aberration can not be realized within Mareshall limit of 0.07 (λrms).

### The Second Embodiment

Referring to the drawings, another embodiment of the present invention will be detailed below.

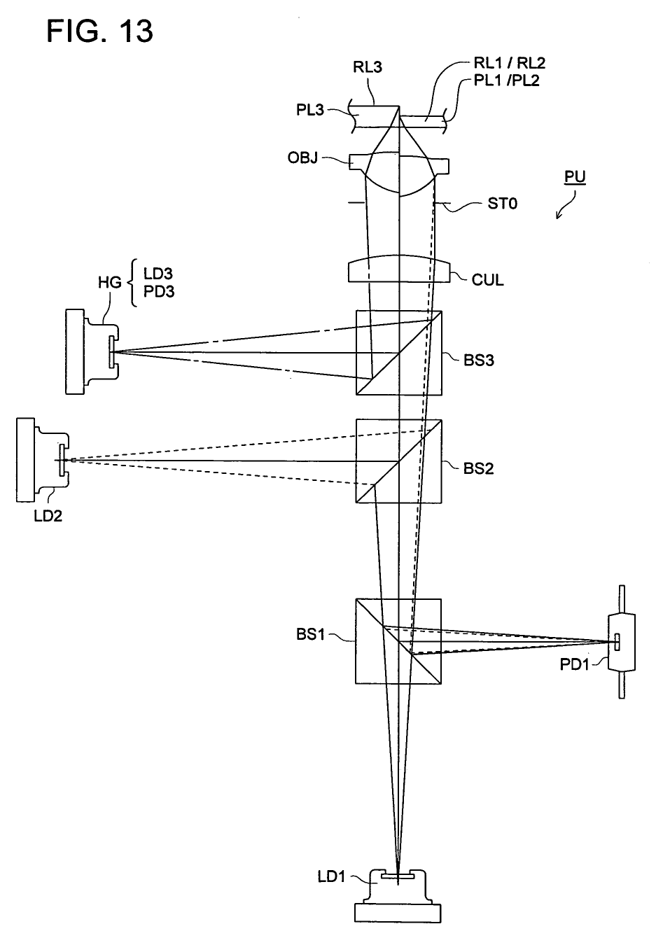

FIG. 13 is a view schematically showing a structure of an optical pickup apparatus PU by which the recording/reproducing of the information can be adequately conducted also on any one of HD (the first optical information recording medium), DVD (the third optical information recording medium) and CD (the second optical information recording medium). The optical specification of HD is, wavelength λ1=407 nm, the thickness t1 of the protective layer (protective substrate) PL1=0.6 mm, numerical aperture NA1=0.65, the optical specification of DVD is, wavelength λ3=655 nm, the thickness t3 of the protective layer PL3=0.6 mm, numerical aperture NA3=0.65, and the optical specification of CD is, wavelength λ2=785 nm, the thickness t2 of the protective layer PL2=1.2 mm, numerical aperture NA2=0.51. However, a combination of the wavelength, thickness of the protective layer, and numerical aperture is not limited to this. Further, as the first optical information recording medium, BD whose thickness t1 of the protective layer PL1 is about 0.0875 mm, may also be used.

Further, the objective lens OBJ of the present embodiment is provided in such a manner that the first light flux of wavelength λ1 and the third light flux of wavelength λ3 are incident as the parallel light, and the second light flux is incident as the divergent light.

The optical pickup apparatus PU consists of: a blue violet semiconductor laser LD1 (the first light source) projecting the laser light flux (the first light flux) of 407 nm which is light-emitted when the recording/reproducing of the information is conducted on HD; a photo detector PD1 for the first light flux; a red semiconductor laser LD3 (the third light source) projecting the laser light flux (the third light flux) of 655 nm which is light-emitted when the recording/reproducing of the information is conducted on DVD; a photo detector PD1 for the first light flux and the third light flux; a hologram laser HG in which a infrared semiconductor laser LD2 (the second light source) projecting the laser light flux (the second light flux) of 785 nm which is light-emitted when the recording/reproducing of the information is conducted on CD, and a photo detector PD2 for the second light flux, are integrated; a coupling lens CUL through which the first—third light fluxes pass; an objective lens OBJ on whose optical surface the diffractive structure as the phase structure is formed, and both surfaces of which are aspheric surfaces having a function by which each of laser light fluxes is light-converged on the information recording surfaces RL1, RL2, and RL3; a 2-axis actuator (not shown) which moves the objective lens OBJ in the predetermined direction; the first beam splitters BS1, second beam splitters BS2, third beam splitters BS3, a stop STO.

In the optical pickup apparatus PU, when the recording/reproducing of the information is conducted on HD, as its ray of light path is drawn by a solid line in FIG. 13, initially, the blue violet semiconductor laser LD1 is emitted. The divergent light flux projected from the blue violet semiconductor laser LD1 passes the first—the third beam splitters BS1-BS3, and reaches the coupling lens CUL.

Then, the first light flux is converted into the parallel light when the light flux passes the coupling lens CUL, passes the stop STO, reaches the objective lens. OBJ, and becomes a spot formed on the information recording surface RL1 through the first protective layer PL1 by the objective lens OBJ. The objective lens OBJ conducts the focusing or tracking by the 2-axis actuator arranged in its periphery.

The reflected light flux modulated by the information pit on the information recording surface RL1, passes again the objective lens OBJ, the third beam splitter BS3, second beam splitter BS2, branched by the first beam splitter BS1, and the light flux is converged on the light receiving surface of the photo-detector PD1. Then, by using the output signal of the photo detector PD1, the information recorded in HD can be read.

Further, when the recording/reproducing of the information is conducted on DVD, as its ray of light path is drawn by a dotted line in FIG. 13, initially, the red semiconductor laser LD3 is emitted. The divergent light flux projected from the red semiconductor laser LD3 is reflected by the second beam splitter BS2, passes the third beam splitter BS3, and reaches the coupling lens CUL.

Then, the second light flux is converted into the parallel light when the light flux passes the coupling lens CUL, passes the stop STO, reaches the objective lens OBJ, and becomes a spot formed on the information recording surface RL3 through the third protective layer PL3 by the objective lens OBJ. The objective lens OBJ conducts the focusing or tracking by the 2-axis actuator arranged in its periphery.

The reflected light flux modulated by the information pit on the information recording surface RL2, passes the objective lens OBJ, coupling lens CUL, the third beam splitter BS3, second beam splitter BS2, and is branched by the first beam splitter BS1, and converged on the light receiving surface of the photo detector PD1. Then, by using the output signal of the photo detector PD1, the information recorded in DVD can be read.

Further, when the recording/reproducing of the information is conducted on CD, as its ray of light path is drawn by a one-dotted chain line in FIG. 13, initially, the infrared semiconductor laser LD2 of the hologram laser HG is light-emitted. The divergent light flux projected from the infrared semiconductor laser LD2 is reflected by the third beam splitter BS2 and reaches the coupling lens CUL.

Then, the second light flux is converted into the divergent angle when the light flux passes the coupling lens CUL, passes the stop STO, reaches the objective lens OBJ, and becomes a spot formed on the information recording surface RL2 through the second protective layer PL2 by the objective lens OBJ. The objective lens OBJ conducts the focusing or tracking by the 2-axis actuator arranged in its periphery.

The reflected light flux modulated by the information pit on the information recording surface RL2, passes the objective lens OBJ, coupling lens CUL, and is branched by the third beam splitter BS3, and is converged on the light receiving surface of the photo detector PD3 of the hologram laser HG. Then, by using the output signal of the photo detector PD3, the information recorded in CD can be read.

Next, the composition of the objective lens OBJ (compound optical element) will be described.

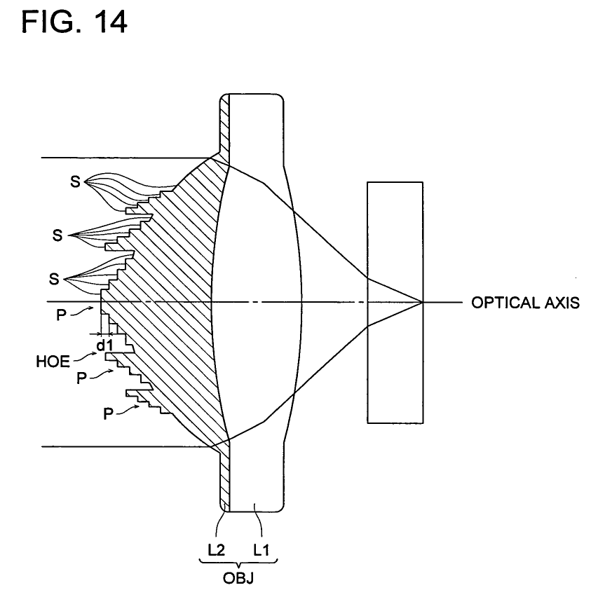

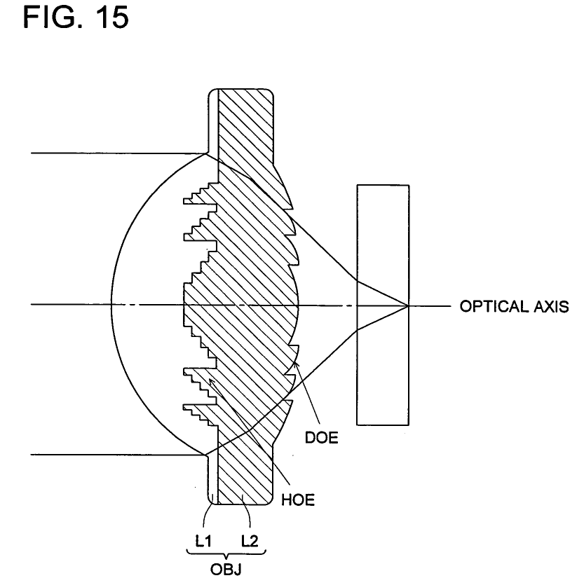

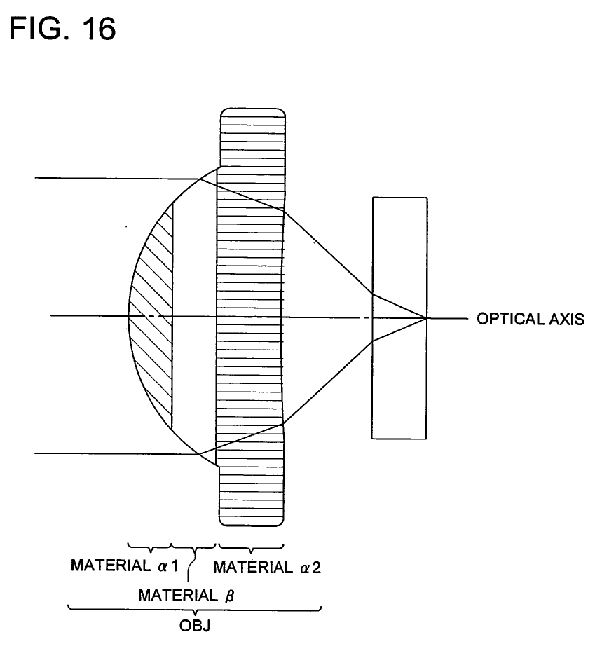

The objective lens is, as schematically shown in FIG. 14, a single lens which is composed in such a manner that a lens part (hereinafter, called “the first lens part L1”) which is formed of the material (hereinafter, called “material A”) whose Abbe number vd for the d-line is 40≦vd≦70, and a lens part (hereinafter, called “the second lens part L2”) formed of the material (hereinafter, called “material B”) whose Abbe number vd for the d-line is 20≦vd<40, are laminated in the optical axis direction (for example, corresponds to Example 3 which will be described later).

Further, on the boundary surface between the second lens part L2 and the air layer, as the phase structure, the diffractive structure HOE which is structured in such a manner that the patterns P whose sectional shape including the optical axis is step shape, are concentric circularly arranged, is formed.

In the diffractive structure HOE, the depth d1 in the optical axis direction of the step difference S formed in each pattern P is set so as to satisfy
0.8×λ1×K2/(nB1−nA1)≦d1≦1.2×λ1×K2/(nB1−nA1).
Where,
NA1: refractive index of the material A to the light flux of wavelength λ1,
NB1: refractive index of the material B to the light flux of wavelength λ1,
K2: natural number.

When the depth d1 in the optical axis direction is set in this manner, in the diffractive structure HOE, the light flux of wavelength λ1 passes without the phase difference being given substantially. Further, because the light flux of wavelength λ2 is, as described above, a ratio of the difference of the refractive index between the material A and the material B becomes large enough due to that the dispersion is different, in the diffractive structure HOE, the phase difference is given substantially to the light flux and the flux receives the diffraction action.

When the lens data in Example 3 is cited, in this diffractive structure, the depth d1 between adjoining ring-shaped zones (step difference) is set to d1=0.407×2/(1.636473−1.5345)=7.98 (μm). Accordingly, when the light of wavelength λ1=0.407 (μm) is incident on this diffractive structure, the phase difference of 2π×2 is generated by the adjoining ring-shaped zones, and substantially, the phase difference is not generated. That is, the light passes in high efficiency (100%)

When the light of wavelength λ2=0.785 (μm) is incident on this diffractive structure, the phase difference of d1×(1.584488−1.5036)/0.785=2π×0.823 is generated by the adjoining ring-shaped zones, however, at the time of 5-step structure in 1 period, 2π×0.823×5=2π×4.11 is obtained, and because it is close to the integer value, the light is diffracted in the high diffraction efficiency (84%).

Further, when the light of wavelength λ3=0.655 (μm) is incident on this diffractive structure, the phase difference of 2π×d1×(1.591925−1.5101)/0.655=2π×0.997 is generated by the adjoining ring-shaped zones, and because substantially there is no phase difference, the light passes in the high diffraction efficiency (100%).

As described above, according to the optical pickup apparatus PU shown in the present embodiment, the light flux of wavelength λ1 (for example, the blue violet laser light flux of wavelength λ1=about 407 nm) and the light flux of wavelength λ2 (for example, the infrared laser light flux of wavelength λ2=about 785 nm) having the relationship whose wavelength ratio is about integer ratio can be projected each other at different angle by using the diffractive structure HOE, for example, the correction of spherical aberration can be conducted or the transmission factor can be secured.

Hereupon, in the present embodiment, the light source unit LU in which the red semiconductor laser LD3 and the infrared semiconductor laser LD2 are integrated, is used, however, not limited to this, the laser light source unit for HD/DVD/CD in which the blue violet semiconductor laser LD1 (the first light source) is also housed in one housing, may also be used.

As a method for laminating the optical resin on the optical glass, there is a method (so-called insert molding) for laminating when the optical glass on whose surface the phase structure is formed is used as a metallic mold, and on the optical glass, the optical resin is molded, however, other than that, a method in which, after the ultraviolet curing resin are laminated on the optical glass on whose surface the phase structure is formed, it is hardened by irradiating the ultraviolet ray, is appropriate in the manufacture. In this method, it is desirable that another surface of the ultraviolet curing resin is a plane.

Further, as a method by which the optical glass on whose surface the phase structure is formed, is manufactured, a method in which the photo-lithography and etching process are repeated, and the phase structure is directly formed on the optical glass substrate, or a method by which a mold (metallic mold) in which the phase structure is formed, is produced, and as a replica of the mold, the optical glass on whose surface the phase structure is formed is obtained, so-called mold molding is appropriate for mass production. Hereupon, a producing method by which a mold in which the phase structure is formed, may be a method by which the phase structure is formed by repeating the photo-lithography and etching process, or a method in which the phase structure is mechanically processed by the precision lathe.

In the above invention, the preferable ranges of wavelengths λ1, λ2, λ3, protective substrate thickness t1, t2, t3 are as follows.
350 nm≦λ1≦450 nm
750 nm≦λ2≦850 nm
600 nm≦λ3≦700 nm
0.0 mm≦t1≦0.7 mm
0.9 mm≦t2≦1.3 mm
0.4 mm≦t3≦0.7 mm

Further, more preferable ranges of them are as follows.
390 nm≦λ1≦415 nm
770 nm≦λ2≦810 nm
635 nm≦λ3≦670 nm
0.5 mm≦t1≦0.7 mm
1.1 mm≦t2≦1.3 mm
0.5 mm≦t3≦0.7 mm

Next, examples of the objective lens shown in above embodiment will be described.

### Example 3

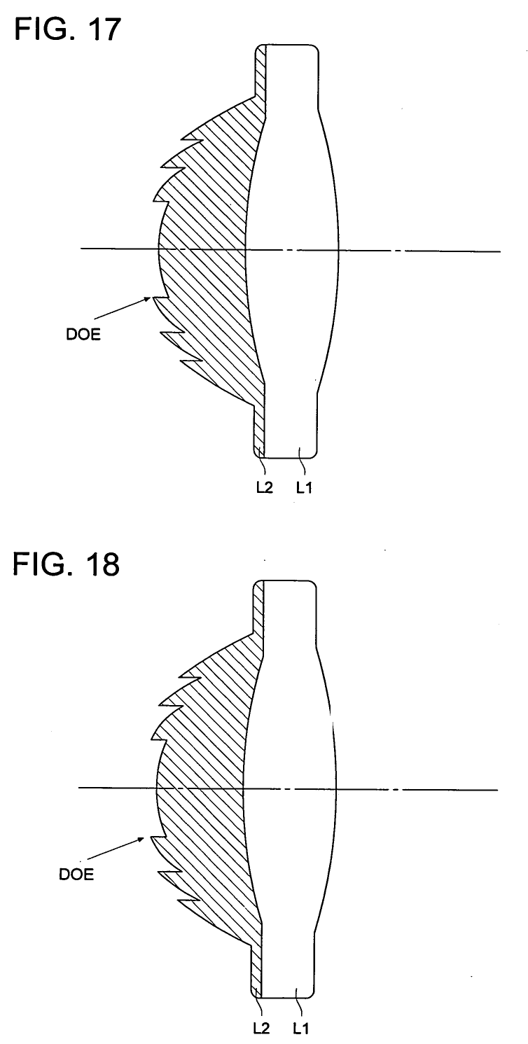

The objective lens of the present example is structured, as shown in FIG. 17, by being laminated in the order of the second lens part L2, the first lens part L1 from the light source side, and on the boundary surface between the second lens part and the air layer, the saw-toothed diffractive structure DOE as the phase structure is formed.

The lens data of Example 3 will be shown in Table 3.

TABLE 3
Example 3 lens data

Focal distance of the objective lens:
f1 = 3.0 mm f3 = 3.09 mm, f2 = 3.11 mm
Image surface side numerical aperture:
NA1: 0.669, NA3: 0.65, NA2: 0.51
Magnification m1: 0, m3: 0, m2: −1/35.1

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | ∞ | | 57.83 | |
| 1 | | 0.0 | | 0.0 | | 0.0 | |
| *1 | | (φ4.014 mm) | | (φ4.014 mm) | | (φ4.014 mm) | |
| 2 | 1.9771 | 0.15 | 1.6365 | 0.15 | 1.5919 | 0.15 | 1.5845 |
| 2′ | 1.9771 | 0.00 | 1.6365 | 0.00 | 1.5919 | 0.00 | 1.5845 |
| 3 | 2.1447 | 1.85 | 1.5428 | 1.85 | 1.5292 | 1.85 | 1.5254 |
| 4 | −8.2174 | 1.09 | 1.0 | 1.13 | 1.0 | 0.95 | 1.0 |
| 5 | ∞ | 0.6 | 1.6187 | 0.6 | 1.5775 | 1.2 | 1.5706 |
| 6 | ∞ | | | | | | |

The 2nd surface (0 mm ≦ h ≦ 1.692 mm)
Aspherical surface coefficient
κ −5.3022E−01
A4 −2.9422E−04
A6 −2.6207E−04
A8 1.0924E−04
A10 −2.1297E−05
A12 7.1410E−06
A14 1.7025E−06
Optical path difference function
(HD DVD: 10th-order, DVD: 6th-order,
CD: 5th-order, manufactured wavelength: 407 nm)
B2 −6.4492E−04
B4 −9.7299E−05
B6 −2.2157E−05
B8 4.7447E−06
B10 1.4964E−07
The 2′nd surface (1.692 mm ≦ h)
Aspherical surface coefficient
κ −5.3022E−01
A4 −2.9422E−04
A6 −2.6207E−04
A8 1.0924E−04
A10 −2.1297E−05
A12 7.1410E−06
A14 −1.7025E−06
Optical path difference function (HD DVD: 5th-order,
DVD: 3rd-order, manufactured wavelength: 407 nm)
B2 −1.2898E−03
B4 −1.9460E−04
B6 −4.4315E−05
B8 9.4894E−06
B10 2.9927E−07
The 3rd surface
Aspherical surface coefficient
κ −5.6846E−01
A4 −2.5097E−03
A6 5.2790E−03
A8 −2.8898E−03
A10 9.9884E−04
A12 −1.8282E−04
A14 1.3544E−05
The 4th surface
Aspherical surface coefficient
κ −1.1512E+02
A4 −4.6465E−03
A6 8.3791E−03
A8 −5.3504E−03
A10 1.5669E−03
A12 −2.4907E−04
A14 1.6994E−05

| | nd | νd |
|---|---|---|
| Material A | 1.5319 | 66.1 |
| Material B | 1.5980 | 28.0 |

*1: (stop diameter)
di′ shows a distance from the I′-th surface to the I-th surface

As shown in Table 3, the objective lens of the present example is an objective lens for HD/DVD/CD compatibility, and is set to such that, when the wavelength λ1=407 nm, the focal distance f1=3.00 mm, magnification m1=0, is set to such that, when the wavelength λ2=785 nm, the focal distance f2=3.11 mm, magnification m2=−1/35.1, and is set to such that, when the wavelength λ3=655 nm, the focal distance f3=3.09 mm, magnification m3=0.

Further, it is set to the refractive index nd on d-line of the material A composing the first lens part L1, nd=1.5319, Abbe number vd in the d-line=66.1, the refractive index nd on d-line of the material B composing the second lens part L2, nd=1.5980, Abbe number vd in the d-line=28.0.

Further, the incident surface of the second lens part is divided into the second surface whose height h around the optical axis is 0 mm≦h≦1.692 mm, and the 2′ surface of 1.692 mm<h.

The incident surface (the 2nd surface, 2′ surface) of the second lens part, the boundary surface (the 3rd surface) between the second lens part and the first lens part, and the projecting surface (the fourth surface) of the first lens part are formed into the aspherical surfaces.

Further, on the 2nd surface and 2′ surface, the diffractive structure DOE is formed. Hereupon, the manufactured wavelength λB of the diffractive structure DOE is 407 nm.

### Example 4

The objective lens of the present example is, as shown in FIG. 18, composed by being laminated in the order of the second lens part L2, the first lens part L1 from the light source side, and on the boundary surface between the second lens part and the air layer, the saw-toothed diffractive structure DOE as the phase structure is formed.

The lens data of Example 4 will be shown in Table 4.

TABLE 4
Example 4 lens data

Focal distance of the objective lens:
f1 = 3.0 mm f3 = 3.11 mm, f2 = 3.09 mm
Image surface side numerical aperture:
NA1: 0.65, NA3: 0.65, NA2: 0.51
Magnification m1: 0, m3: 0, m2: −1/20.5

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | ∞ | | 66.27 | |
| 1 | | 0.0 | | 0.0 | | 0.0 | |
| *1 | | (φ3.900 mm) | | (φ4.043 mm) | | (φ3.295 mm) | |
| 2 | 2.1708 | 0.10 | 1.6498 | 1.10 | 1.6011 | 1.10 | 1.5947 |
| 3 | 1.5187 | 1.40 | 1.6051 | 1.40 | 1.5860 | 1.40 | 1.5819 |
| 4 | −9.1651 | 1.20 | 1.0 | 1.31 | 1.0 | 1.06 | 1.0 |
| 5 | ∞ | 0.6 | 1.6187 | 0.6 | 1.5775 | 1.2 | 1.5706 |
| 6 | ∞ | | | | | | |

The 2nd surface
Aspherical surface coefficient
κ −5.2127E−01
A4 1.1747E−03
A6 −4.6776E−04
A8 2.3610E−04
A10 −9.1976E−05
A12 1.5921E−05
A14 −1.4418E−06
Optical path difference function
(HD DVD: 2nd-order, DVD: 1st-order,
CD: 1st-order, manufactured wavelength: 407 nm)
B2 −5.6203E−03
B4 −2.1508E−04
B6 −5.3304E−05
B8 −8.1372E−06
B10 2.8719E−06
The 3rd surface
Aspherical surface coefficient
κ −1.5742E+00
A4 4.3892E−02
A6 2.0232E−03
A8 3.7228E−03
A10 −1.4613E−03
A12 6.6287E−05
A14 −9.7816E−06
The 4th surface
Aspherical surface coefficient
κ −1.4114E+02
A4 7.6297E−04
A6 5.3392E−03
A8 −5.5593E−03
A10 2.2179E−03
A12 −4.3315E−04
A14 3.3147E−05

| | nd | νd |
|---|---|---|
| Material A | 1.5890 | 59.7 |
| Material B | 1.6072 | 27.6 |

*1: (stop diameter)
di′ shows a distance from the I′-th surface to the I-th surface

As shown in Table 4, the objective lens of the present example is an objective lens for HD/DVD/CD compatibility, and is set to such that, when the wavelength λ1=407 nm, the focal distance f1=3.00 mm, magnification m1=0, and is set to such that, when the wavelength λ2=785 nm, the focal distance f2=3.09 mm, magnification m2=−1/20.5, and is set to such that, when the wavelength λ3=655 nm, the focal distance f3=3.11 mm, magnification m3=0.

Further, it is set to the refractive index nd on d-line of the material A (glass) composing the first lens part L1, nd=1.5890, Abbes' number vd on the d-line=59.7, the refractive index nd on d-line of the material B composing the second lens part L2, nd=1.6072, Abbe number vd for the d-line=27.6.

The incident surface (the 2nd surface) of the second lens part, the boundary surface (the 3rd surface) between the second lens part and the first lens part, and the projecting surface (the fourth surface) of the first lens part are formed into the aspherical surfaces.

Further, on the 2nd surface, the diffractive structure DOE is formed. Hereupon, the manufactured wavelength λB of the diffractive structure DOE is 407 nm.

### Example 5

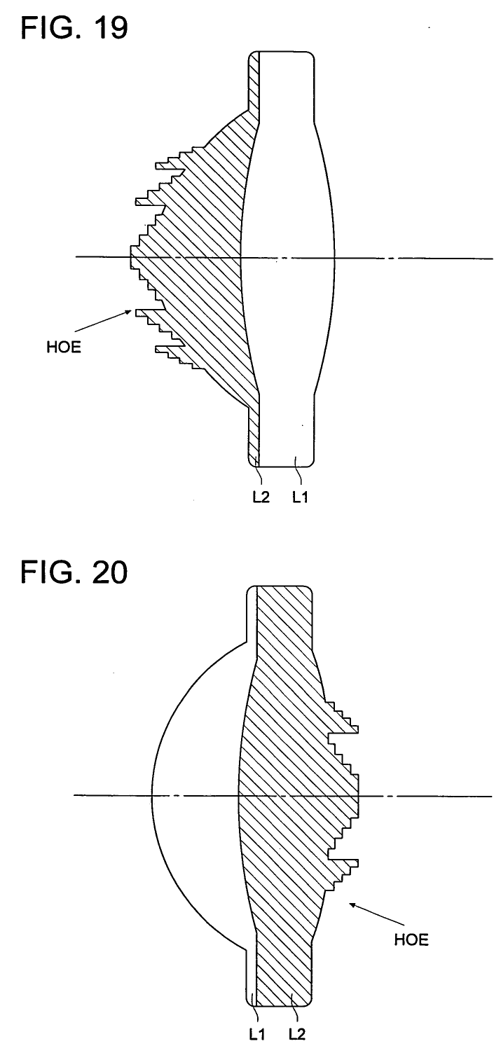

The objective lens of the present example is, as shown in FIG. 19, composed by being laminated in the order of the second lens part L2, the first lens part L1 from the light source side, and on the boundary surface between the second lens part and the air layer, the diffractive structure HOE as the phase structure is formed.

The lens data of Example 5 will be shown in Table 5.

TABLE 5
Example 5 lens data
Focal distance of the objective lens:
f1 = 3.0 mm f3 = 3.12 mm, f2 = 3.10 mm
Image surface side numerical aperture:
NA1: 0.65, NA3: 0.65, NA2: 0.51
Magnification m1: 0, m3: 0, m2: 0

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| *1 | | (φ3.900 mm) | | (φ4.056 mm) | | (φ4.056 mm) | |
| 2 | 2.1131 | 1.10 | 1.6498 | 1.10 | 1.6011 | 1.10 | 1.5947 |
| 2′ | 2.1131 | 0.00 | 1.6498 | 0.00 | 1.6011 | 0.00 | 1.5947 |
| 3 | 2.3241 | 1.40 | 1.6051 | 1.40 | 1.5860 | 1.40 | 1.5819 |
| 4 | −7.9463 | 1.25 | 1.0 | 1.36 | 1.0 | 0.95 | 1.0 |
| 5 | ∞ | 0.6 | 1.6187 | 0.6 | 1.5775 | 1.2 | 1.5706 |
| 6 | ∞ | | | | | | |

*1: (stop diameter)
di′ shows a distance from the I′-th surface to the I-th surface

The 2nd surface (0 mm ≦ h ≦ 1.581 mm)
Aspherical surface coefficient

| | |
|---|---|
| κ | −5.1962E−01 |
| A4 | 1.1777E−03 |
| A6 | −4.1299E−04 |
| A8 | 2.3850E−04 |
| A10 | −9.2086E−05 |
| A12 | 1.5943E−05 |
| A14 | −1.8029E−06 |

Optical path difference function
(HD DVD: 0-order, DVD: 0-order, CD: 1st-order,
manufactured wavelength: 785 nm)

| | |
|---|---|
| B2 | −2.4614E−03 |
| B4 | −2.8518E−04 |
| B6 | −8.5393E−05 |
| B8 | 1.3383E−05 |
| B10 | −2.1879E−06 |

The 2′nd surface (1.581 mm ≦ h)
Aspherical surface coefficient

| | |
|---|---|
| κ | −5.1962E−01 |
| A4 | 1.1777E−03 |
| A6 | −4.1299E−04 |
| A8 | 2.3850E−04 |
| A10 | −9.2086E−05 |
| A12 | 1.5943E−05 |
| A14 | −1.8029E−06 |

The 3rd surface
Aspherical surface coefficient

| | |
|---|---|
| κ | −1.7903E+00 |
| A4 | 2.4539E−02 |
| A6 | −6.4924E−03 |
| A8 | 3.1101E−03 |
| A10 | −1.1781E−03 |
| A12 | 2.4835E−04 |
| A14 | −2.4957E−05 |

The 4th surface
Aspherical surface coefficient

| | |
|---|---|
| κ | −9.8485E+01 |
| A4 | 6.3017E−05 |
| A6 | 5.5784E−03 |
| A8 | −5.5483E−03 |
| A10 | 2.1902E−03 |
| A12 | −4.3963E−04 |
| A14 | 3.6029E−05 |

| | nd | νd |
|---|---|---|
| Material A | 1.5890 | 59.7 |
| Material B | 1.6072 | 27.6 |

As shown in Table 5, the objective lens of the present example is an objective lens for HD/DVD/CD compatibility, and is set to such that, when the wavelength λ1=407 nm, the focal distance f1=3.00 mm, magnification m1=0, and is set to such that, when the wavelength λ2=785 nm, the focal distance f2=3.10 mm, magnification m2=0, and is set to such that, when the wavelength λ3=655 nm, the focal distance f3=3.12 mm, magnification m3=0.

Further, it is set to the refractive index nd on d-line of the material A composing the first lens part L1, nd=1.5890, Abbes' number vd on the d-line=59.7, the refractive index nd on d-line of the material B composing the second lens part L2, nd=1.6072, Abbes' number vd on the d-line=27.6.

Further, the incident surface of the second lens part is divided into the second surface whose height h around the optical axis is 0 mm≦h≦1.581 mm, and the 2′ surface of 1.581 mm<h.

The 2nd surface, 2′ surface, the boundary surface (the 3rd surface) between the second lens part and the first lens part, and the projecting surface (the fourth surface) of the first lens part are formed into the aspherical surfaces.

Further, on the 2nd surface, the diffractive structure HOE is formed. Hereupon, the manufactured wavelength λB of the diffractive structure HOE is 785 nm.

### Example 6

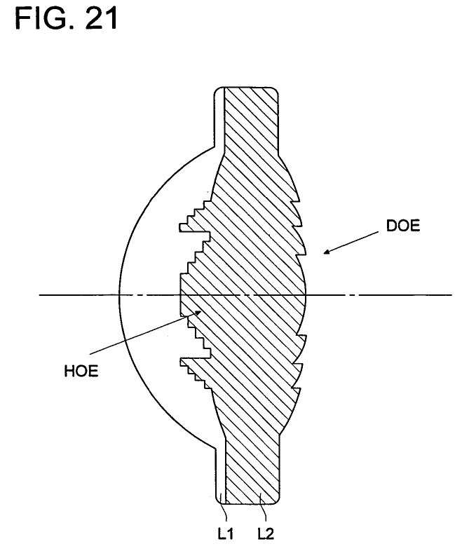

The objective lens of the present example is, as shown in FIG. 20, composed by being laminated in the order of the first lens part L1, the second lens part L2 from the light source side, and on the boundary surface between the second lens part and the air layer, the diffractive structure HOE as the phase structure is formed.

The lens data of Example 6 will be shown in Table 6.

TABLE 6
Example 6 lens data
Focal distance of the objective lens:
f1 = 2.2 mm f3 = 2.26 mm, f2 = 3.74 mm
Image surface side numerical aperture:
NA1: 0.85, NA3: 0.65, NA2: 0.51
Magnification m1: 0, m3: −1/17.7, m2: 0

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | −39.00 | | ∞ | |
| 1 | | 0.0 | | 0.0 | | 0.0 | |
| *1 | | (φ3.74 mm) | | (φ2.860 mm) | | (φ2.860 mm) | |
| 2 | 1.5542 | 1.70 | 1.5428 | 1.85 | 1.5292 | 1.85 | 1.5254 |
| 3 | −5.0344 | 1.10 | 1.6498 | 1.10 | 1.6011 | 1.10 | 1.5947 |
| 4 | −2.1462 | 0.32 | 1.0 | 0.39 | 1.0 | 0.04 | 1.0 |
| 4′ | −2.1462 | 0 | 1.0 | 0.00 | 1.0 | 0.00 | 1.0 |
| 5 | ∞ | 0.0875 | 1.6187 | 0.6 | 1.5775 | 1.2 | 1.5706 |
| 6 | ∞ | | | | | | |

*1: (stop diameter)
di′ shows a distance from the I′-th surface to the I-th surface

The 2nd surface
Aspherical surface coefficient

| | |
|---|---|
| κ | −6.8034E−01 |
| A4 | 6.5476E−03 |
| A6 | 2.9046E−03 |
| A8 | −6.4037E−04 |
| A10 | 1.7991E−04 |
| A12 | 4.3404E−05 |
| A14 | −1.3667E−05 |
| A16 | −2.9442E−06 |
| A18 | −1.3039E−06 |
| A20 | 5.0225E−07 |

The 3rd surface
Aspherical surface coefficient

| | |
|---|---|
| κ | −8.0064E+00 |
| A4 | 1.1219E−02 |
| A6 | 3.2612E−03 |
| A8 | −9.2701E−04 |
| A10 | 1.2492E−04 |
| A12 | 1.6820E−05 |
| A14 | −1.8650E−05 |
| A16 | −3.4590E−06 |
| A18 | −1.3478E−06 |
| A20 | 6.0951E−07 |

The 4th surface (0 mm ≦ h ≦ 0.462 mm)
Aspherical surface coefficient

| | |
|---|---|
| κ | −7.3786E+00 |
| A4 | 1.6342E−01 |
| A6 | −4.1299E−04 |
| A8 | 1.0568E−01 |
| A10 | −3.5872E−02 |
| A12 | 5.1021E−03 |

Optical path difference function
(HD DVD: 0-order, DVD: 0-order, CD: 1st-order,
manufactured wavelength: 785 nm)

| | |
|---|---|
| B2 | −6.5900E−02 |
| B4 | 2.2622E−02 |
| B6 | 6.6208E−02 |
| B8 | −3.4810E−01 |
| B10 | 5.0091E−01 |

The 4′ th surface (0.462 mm ≦ h)
Aspherical surface coefficient

| | |
|---|---|
| κ | −7.3786E+00 |
| A4 | 1.6342E−01 |
| A6 | −4.1299E−04 |
| A8 | 1.0568E−01 |
| A10 | −3.5872E−02 |
| A12 | 5.1021E−03 |

| | nd | νd |
|---|---|---|
| Material A | 1.5319 | 66.1 |
| Material B | 1.6072 | 27.6 |

As shown in Table 6, the objective lens of the present example is an objective lens for BD/DVD/CD compatibility, and is set to such that, when the wavelength λ1=407 nm, the focal distance f1=2.20 mm, magnification m1=0, and is set to such that, when the wavelength λ2=785 nm, the focal distance f2=3.47 mm, magnification m2=0, and is set to such that, when the wavelength λ3=655 nm, the focal distance f3=2.26 mm, magnification m3=−1/17.7.

Further, it is set to the refractive index nd on d-line of the material A composing the first lens part L1, nd=1.5319, Abbes' number vd on the d-line=66.1, the refractive index nd on d-line of the material B composing the second lens part L2, nd=1.6072, Abbes' number vd on the d-line=27.6.

Further, the projecting surface of the second lens part is divided into the 4th surface whose height h around the optical axis is 0 mm≦h≦0.462 mm, and the 4′th surface of 0.462 mm<h.

The incident surface of the first lens part (2nd surface), the boundary surface (the 3rd surface) between the first lens part and the second lens part, and the 4th surface and the 4′th surface are formed into the aspherical surfaces.

Further, on the 4th surface, the diffractive structure HOE is formed. Hereupon, the manufactured wavelength λB of the diffractive structure HOE is 785 nm.

### Example 7

The objective lens of the present example is, as shown in FIG. 21, composed by being laminated in the order of the first lens part L1, the second lens part L2 from the light source side, and on the boundary surface between the second lens part and the air layer, the saw-toothed diffractive structure DOE as the phase structure is formed, and also on the boundary surface between the first lens part and the second lens part, the diffractive structure HOE as the phase structure is formed,

The lens data of Example 7 will be shown in Table 7.

TABLE 7
Example 7 lens data
Focal distance of the objective lens:
f1 = 2.2 mm f3 = 2.30 mm, f2 = 3.14 mm
Image surface side numerical aperture:
NA1: 0.85, NA3: 0.65, NA2: 0.51
Magnification m1: 0, m3: 0, m2: 0

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | −39.00 | | ∞ | |
| 1 | | 0.0 | | 0.0 | | 0.0 | |
| *1 | | (φ3.74 mm) | | (φ2.99 mm) | | (φ3.203 mm) | |
| 2 | 1.5764 | 1.90 | 1.5428 | 1.90 | 1.5292 | 1.90 | 1.5254 |
| 3 | −6.1963 | 0.80 | 1.6498 | 0.80 | 1.6011 | 0.80 | 1.5947 |
| 3′ | −6.1963 | 0.00 | 1.6498 | 0.00 | 1.6011 | 0.00 | 1.5947 |
| 4 | −4.4325 | 0.37 | 1.0 | 0.58 | 1.0 | 0.10 | 1.0 |
| 5 | ∞ | 0.0875 | 1.6187 | 0.6 | 1.5775 | 1.2 | 1.5706 |
| 6 | ∞ | | | | | | |

*1: (stop diameter)
di′ shows a distance from the I′-th surface to the I-th surface

The 2nd surface
Aspherical surface coefficient

| | |
|---|---|
| κ | −6.6854E−01 |
| A4 | 5.7223E−03 |
| A6 | 2.1228E−03 |
| A8 | 5.7198E−05 |
| A10 | −1.4373E−05 |
| A12 | 4.2164E−05 |
| A14 | 7.9085E−07 |
| A16 | 8.1275E−07 |
| A18 | −1.0384E−06 |
| A20 | 3.2250E−07 |

The 3rd surface (0 mm ≦ h ≦ 0.708 mm)
Aspherical surface coefficient

| | |
|---|---|
| κ | −1.5848E+02 |
| A4 | 2.7742E−02 |
| A6 | 5.8331E−03 |
| A8 | −1.3535E−04 |
| A10 | 2.4334E−04 |
| A12 | −1.3476E−04 |
| A14 | −1.1797E−05 |
| A16 | 5.0574E−07 |
| A18 | 4.0622E−06 |
| A20 | 2.3413E−06 |

Optical path difference function (HD DVD: 0-order,
DVD: 0-order, CD: 1st-order, manufactured wavelength:
785 nm)

| | |
|---|---|
| B2 | −2.5614E−02 |
| B4 | 5.1044E−04 |
| B6 | 2.3337E−03 |
| B8 | −4.8063E−03 |
| B10 | 2.5108E−03 |

The 3′ rd surface (0.708 mm ≦ h)
Aspherical surface coefficient

| | |
|---|---|
| κ | −1.5848E+02 |
| A4 | 2.7742E−02 |
| A6 | 5.8331E−03 |
| A8 | −1.3535E−04 |
| A10 | 2.4334E−04 |
| A12 | −1.3476E−04 |
| A14 | −1.1797E−05 |
| A16 | 5.0574E−07 |
| A18 | 4.0622E−06 |
| A20 | 2.3413E−06 |

The 4th surface

| | |
|---|---|
| κ | −7.3786E+00 |
| A4 | 1.6342E−01 |
| A6 | −1.7346E−01 |
| A8 | 1.0568E−01 |
| A10 | −3.5872E−02 |
| A12 | 5.1021E−03 |

Optical path difference function (HD DVD: 2nd-order,
DVD: 1st-order, CD: 1st-order, manufactured wavelength:
407 nm)

| | |
|---|---|
| B2 | −3.6044E−02 |
| B4 | 1.1410E−02 |
| B6 | 6.8212E−03 |
| B8 | 6.9426E−04 |
| B10 | 6.0891E−04 |

| | nd | νd |
|---|---|---|
| Material A | 1.5319 | 66.1 |
| Material B | 1.6072 | 27.6 |

As shown in Table 7, the objective lens of the present example is an objective lens for BD/DVD/CD compatibility, and is set to such that, when the wavelength λ1=407 nm, the focal distance f1=2.20 mm, magnification m1=0, and is set to such that, when the wavelength λ2=785 nm, the focal distance f2=3.14 mm, magnification m2=0, and is set to such that, when the wavelength λ3=655 nm, the focal distance f3=2.30 mm, magnification m3=0.

Further, it is set to the refractive index nd on d-line of the material A composing the first lens part L1, nd=1.5319, Abbes' number vd on the d-line=66.1, the refractive index nd on d-line of the material B composing the second lens part L2, nd=1.6072, Abbes' number vd on the d-line=27.6.

Further, the boundary surface between the first lens part and the second lens part is divided into the 3rd surface whose height h around the optical axis is 0 mm≦h≦0.708 mm, and the 3′rd surface of 0.708 mm<h.

The incident surface of the first lens part (2nd surface), the 3rd surface, 3′rd surface, and the projecting surface (the 4th surface) of the second lens part are formed into the aspherical surfaces.

Further, on the 3rd surface, the diffractive structure HOE is formed, and on the 4th surface, the diffractive structure DOE is formed. Hereupon, the manufactured wavelength λB of the diffractive structure HOE is 785 nm, and the manufactured wavelength λB of the diffractive structure DOE is 407 nm.

Table 8 shows the diffraction efficiency when each of the light fluxes having wavelengths λ1, λ2 and λ3 (indicated as HD, DVD and CD in the drawing) passes through each surface, in the objective optical system shown in the embodiments 3 through 7. Table 8 indicates that high diffraction efficiency can be obtained for each of the light fluxes having wavelengths λ1, λ2 and λ3 by the objective lens shown in each of the aforementioned embodiments.

TABLE 8
Summarized diffraction effects

| | Surface | | | |
|---|---|---|---|---|
| | number | HD | DVD | CD |
| Embodiment 3 | 2nd surface | 100.0 | 84.9 | 82.6 |
| | 2′nd surface | 100.0 | 96.0 | — |
| Embodiment 4 | 2nd surface | 100.0 | 92.8 | 99.1 |
| Embodiment 5 | 2nd surface | 100.0 | 64.3 | 65.7 |
| Embodiment 6 | 2nd surface | 100.0 | 64.3 | 65.7 |
| Embodiment 7 | 3rd surface | 100.0 | 80.9 | 68.2 |
| | 4th surface | 100.0 | 92.8 | 99.1 |

What is claimed is:

1. A compound optical element for an optical pickup apparatus, comprising:
an aspherical lens and
a resin layer arranged on at least one optical surface of the aspherical lens and having a phase structure,
wherein the compound optical element satisfies
0.8≦(L′/L)≦1.2
where L′ is an optical path length of a light flux which enters into the compound optical element and passes the resin layer on an edge of an effective diameter which corresponds to a necessary numerical aperture, and
L is an optical path length of a light flux which enters into the compound optical element and passes the resin layer on an optical axis.

2. The compound optical element of claim 1,
wherein the compound optical element is arranged in an optical path of a light flux with a wavelength λ1 (390 nm≦λ1≦420 nm) for reproducing and recording information on an optical information recording medium with a necessary numerical aperture of 0.8 or more in the optical pickup apparatus and
when the light flux with the wavelength λ1 passes through the resin layer, the compound optical element satisfies
0.9≦(t′/t)≦2.5
where t′(μm) is a thickness of the resin layer on the edge of the effective diameter,
t(μm) is a thickness of the resin layer on the optical axis, and
each of t and t′ is a length of a line segment
from a first point where the light flux with the wavelength λ1 intersects a surface of the resin layer,
to a second point where a line segment starting from the first point and running parallel to the optical axis intersects a boundary between the resin layer and the aspherical lens.

3. The compound optical element of claim 2,
wherein the compound optical element converges the light flux with the wavelength λ1 and at least one light flux with a wavelength being different from the wavelength λ1 on respective information recording surfaces of different optical information recording media.

4. The compound optical element of claim 1,
wherein the compound optical element is arranged in an optical path of a light flux with a wavelength λ1 (390 nm≦λ1≦420 nm) for reproducing and recording information on an optical information recording medium with a necessary numerical aperture of 0.6 or more in the optical pickup apparatus and
when the light flux with a wavelength λ1 passes through the resin layer, the compound optical element satisfies
1.0≦(t′/t)≦2.0
where t′(μm) is a thickness of the resin layer on the edge of the effective diameter,
t(μm) is a thickness of the resin layer on the optical axis, and
each of t and t′ is a length of a line segment
from a first point where the light flux with the wavelength λ1 intersects a surface of the resin layer,
to a second point where a line segment starting from the first point and running parallel to the optical axis intersects a boundary between the resin layer and the aspherical lens.

5. The compound optical element of claim 4,
wherein the compound optical element converges the light flux with the wavelength λ1 and at least one light flux with a wavelength being different from the wavelength λ1 on respective information recording surfaces of different optical information recording media.

6. The compound optical element of claim 1,
wherein the resin is an ultraviolet curing resin.

7. The compound optical element of claim 1,
wherein the compound optical element satisfies
(n1/n2)≦1.2
where n1 is a refractive index of the aspherical lens for the wavelength λ1 and
n2 is a refractive index of the cured resin for the wavelength λ1.

8. The compound optical element of claim 1,
wherein the thickness t (μm) of the resin layer on the optical axis satisfies 10≦t≦1000.

9. The compound optical element of claim 1,
wherein the aspherical lens is made of plastic.

10. The compound optical element of claim 1,
wherein the aspherical lens is made of glass.

11. The compound optical element of claim 10,
wherein the aspherical lens is a molded glass lens.

12. The compound optical element of claim 1,
wherein the compound optical element is an objective lens of the optical pickup apparatus.

13. The compound optical element of claim 1,
wherein the optical pickup apparatus is provided with an objective lens including two or more optical elements and the compound optical element is one of the two or more optical elements.

14. The compound optical element of claim 1,
wherein the resin layer is formed on each of an incident surface and an emerging surface of the aspherical lens.

15. A compound optical element for use in an optical pickup apparatus at least reproducing and/or recording information using a light flux with a wavelength λ1 emitted by a first light source for a first optical information recording medium having a protective substrate with a thickness t1 and reproducing and/or recording information using a light flux with a wavelength λ2 (1.8×λ1≦λ2≦2.2×λ1) emitted by a second light source for a second optical information recording medium having a protective substrate with a thickness t2 (1.7×t1≦t2), the objective lens comprising:
a first lens part formed of a material A having an Abbe number vd for a d-line satisfies 20≦vdA≦40;
a second lens part laminated on the first lens part in a direction of an optical axis and formed of a material B having an Abbe number vd for a d-line satisfies 40≦vdB≦70, wherein the first lens part and the second lens part form one lens body; and
a phase structure formed on a boundary between the first lens part and air.

16. An optical pickup apparatus comprising:
a light source and
an objective lens for converging a light flux emitted by the light source on an information recording surface of an optical information recording medium, including the compound optical element of claim 1.

17. An optical pickup apparatus comprising:
a first light source for emitting a first light flux with a wavelength λ1 for reproducing and/or recording information on a first optical disc having a protective substrate with a thickness t1;
a second light source for emitting a second light flux with a wavelength λ2 (1.8×λ1≦λ2≦2.2×λ1) for reproducing and/or recording information on a second optical disc having a protective substrate with a thickness t2 (1.7×t1≦t2); and
an objective lens for converging the first light flux and the second light flux on the information recording surfaces of the first and second optical information recording media, respectively, including the compound optical element of claim 15.
